(19) United States
(12) Patent Application Publication
(10) Pub. No.: US 2015/0222838 A1
(43) Pub. Date: Aug. 6, 2015

(54) ULTRASOUND DIAGNOSTIC DEVICE, ULTRASOUND DIAGNOSTIC DEVICE CONTROL METHOD, AND ULTRASOUND DIAGNOSTIC DEVICE CONTROL APPARATUS

(71) Applicant: KONICA MINOLTA, INC., Chiyoda-ku, Tokyo (JP)

(72) Inventors: Akihiro Kawabata, Hachioji-shi (JP); Takashi Kimoto, Yokohama-shi (JP); Yushi Nishimura, Hachioji-shi (JP); Yoshihiko Itoh, Yamato-shi (JP)

(73) Assignee: KONICA MINOLTA, INC., Chiyoda-ku, Tokyo (JP)

(21) Appl. No.: 14/429,351

(22) PCT Filed: Sep. 18, 2013
(86) PCT No.: PCT/JP2013/005518

§ 371 Date: Mar. 18, 2015

(30) Foreign Application Priority Data
Sep. 19, 2012 (JP) 2012-205278

(51) Int. Cl. H04N 5/376; G06T 7/00

(52) U.S. Cl. CPC H04N 5/3765; G06T 7/0012; G06T 2207/10132

(57) ABSTRACT

In an ultrasound diagnostic device, when an operation inputter receives operation input instructing to change a D-mode image to be displayed while a D-mode image is frozen or cine-played back, an image controller newly generates a D-mode image and a trace waveform with respect to another partial range on the time axis of Doppler spectrum data in accordance with the operation input, and controls a display device to display the generated D-mode image, a cardiac cycle period selector detects cardiac cycle periods shown in the newly generated D-mode image from the generated trace waveform, and selects at least one cardiac cycle period from among the detected cardiac cycle periods as a measurement target cardiac cycle period according to a selection criterion, and a measure measures a diagnostic parameter with use of part of the generated trace waveform corresponding to the selected measurement target cardiac cycle period.

### TECHNICAL FIELD

The present invention relates to an ultrasound diagnostic device that measures various diagnostic parameters relating to blood flow within a living organism by taking advantage of the ultrasound Doppler effect, a control method of the ultrasound diagnostic device, and a control circuit of the ultrasound diagnostic device.

### BACKGROUND ART

An ultrasound diagnostic device is a device that generates an ultrasound image showing information on the inside of a subject based on reception signals obtained through transmission and reception of an ultrasound wave aimed at the inside of the subject via an ultrasound probe having piezoelectric elements. Ultrasound images generated by the ultrasound diagnostic device for example include so-called brightness mode (B-mode) images and Doppler mode (D-mode) images.

A B-mode image is an image showing an organ and so on of the subject in the form of tomographic image. In the B-mode image, the organ and so on of the subject is two-dimensionally shown by converting a reflected ultrasound wave received by the ultrasound probe to a brightness signal corresponding to magnitude of amplitude of the reflected ultrasound wave.

On the other hand, a D-mode image is an image showing temporal variation of blood flow velocity at an arbitrary position of the subject. The D-mode image shows Doppler spectrum data in which power (intensity) of flow velocity (frequency) components is plotted as brightness (gradation) for example with time (t) on the horizontal axis and flow velocity (V) corresponding to frequency on the vertical axis (hereinafter, referred to as displayed as a spectrum or spectral display). The Doppler spectrum data is generated by performing fast fourier transform (FFT) frequency analysis on reception signals obtained by continuously transmitting an ultrasound wave toward a particular part inside a subject and receiving a reflected ultrasound wave from the inside of the subject via an ultrasound probe having piezoelectric elements.

In order to display a D-mode image on the ultrasound diagnostic device, a sample gate is for example designated at a desired position on a B-mode image displayed on a display device that is connected with the ultrasound diagnostic device, and Doppler spectrum data is obtained from a reflected ultrasound wave at the position. After that, a D-mode image is generated in which the Doppler spectrum data is displayed as a spectrum, and the D-mode image is displayed on the display device. Generally, a D-mode image shows part of Doppler spectrum data corresponding to a plurality of cardiac cycles that is temporally continuously displayed as a spectrum. The D-mode image is successively updated over time.

After that, various diagnostic parameters relating to blood flow within the subject are measured based on the Doppler spectrum data and the D-mode image which are obtained in this way. In conventional measurement of various diagnostic parameters, a D-mode image, which is generated from Doppler spectrum data obtained in real time, is suspended to be updated. While the D-mode image as of a time of the suspension is continuously displayed (hereinafter, referred to as frozen), an operator performs a manual operation to designate a measurement target position and so on on the D-mode image while watching the frozen D-mode image.

In recent years, compared with this, there has been proposed an ultrasound diagnostic device that automatically measures various diagnostic parameters from Doppler spectrum data that is obtained in real time.

For example, Patent Literature 1 proposes an art of generating a trace waveform by connecting a point of the maximum flow velocity and a point of the average flow velocity for each time of Doppler spectrum data obtained in real time, and automatically measuring various diagnostic parameters with use of the generated trace waveform.

Also, Patent Literature 2 proposes an art of automatically measuring various diagnostic parameters with use of a trace waveform of Doppler spectrum data obtained in real time, and highlighting a range on a D-mode image with respect to which the various diagnostic parameters have been measured while the D-mode image is displayed in real time or frozen.

### CITATION LIST

### Patent Literature

[Patent Literature 1] Japanese Patent Application Publication No. 2003-284718

[Patent Literature 2] Japanese Patent Application Publication No. 2005-81081

### SUMMARY OF INVENTION

### Technical Problem

However, there is a case where various diagnostic parameters relating to blood flow are measured after a D-mode image of Doppler spectrum data obtained in real time is frozen once. In such a case, according to conventional measurement of various diagnostic parameters as described above, an operator needs to perform a complicated manual operation of designating a measurement target position and so on on a D-mode image to measure the various diagnostic parameters while watching the displayed D-mode image.

Also, in the case where a D-mode image, which is generated based on Doppler spectrum data obtained in the past, is cine-played back, an operator needs to perform a complicated manual operation to measure various diagnostic parameters while watching the displayed D-mode image.

The present invention aims to solve the conventional problem and provide an ultrasound diagnostic device capable of measuring various diagnostic parameters only with a simple operation in the case where a D-mode image is frozen or in the case where a D-mode image showing past cardiac cycles is cine-played back, a control method of the ultrasound diagnostic device, and a control circuit of the ultrasound diagnostic device.

### Solution to Problem

In order to achieve the above aim, an ultrasound diagnostic device that is connectable with a recording medium and a display device, the ultrasound diagnostic device comprising: an operation inputter that receives an operation input from a user; an image controller that reads Doppler spectrum data corresponding to a plurality of cardiac cycles that is recorded in the recording medium, generates a D-mode image and a trace waveform with respect to a partial range on a time axis of the Doppler spectrum data, and controls the display device to display part or all of the D-mode image; a cardiac cycle period selector that detects a plurality of cardiac cycle periods shown in the D-mode image from the trace waveform, and selects at least one cardiac cycle period from among the detected cardiac cycle periods as a measurement target cardiac cycle period according to a predetermined selection criterion; and a measure that measures a predetermined diagnostic parameter with use of part of the trace waveform corresponding to the measurement target cardiac cycle period, wherein when the operation inputter receives an operation input instructing to change a D-mode image to be displayed from the D-mode image that is displayed to another D-mode image, the image controller newly generates the other D-mode image and a trace waveform with respect to another partial range on the time axis of the Doppler spectrum data in accordance with the operation input, and controls the display device to display the newly generated D-mode image, the cardiac cycle period selector newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and the measure measures the diagnostic parameter with use of part of the newly generated trace waveform corresponding to the newly selected measurement target cardiac cycle period.

Also, a control method relating to one aspect of the present invention is a control method of an ultrasound diagnostic device that is connectable with a recording medium and a display device, the control method comprising: a generation step of generating Doppler spectrum data corresponding to a plurality of cardiac cycles from reception signals that are obtained through transmission and reception of an ultrasound wave aimed at the inside of a subject; an operation input step of receiving an operation input from a user; a recording step of recording the Doppler spectrum data in the recording medium; an image control step of reading the recorded Doppler spectrum data, generating a D-mode image and a trace waveform with respect to a partial range on a time axis of the Doppler spectrum data, and controlling the display device to display part or all of the D-mode image; a selection step of detecting a plurality of cardiac cycle periods shown in the D-mode image from the trace waveform, and selecting at least one cardiac cycle period from among the detected cardiac cycle periods as a measurement target cardiac cycle period according to a predetermined selection criterion; and a measurement step of measuring a predetermined diagnostic parameter with use of part of the trace waveform corresponding to the measurement target cardiac cycle period, wherein when the operation input step receives an operation input instructing to change a D-mode image to be displayed from the D-mode image that is displayed to another D-mode image, the generation step newly generates the other D-mode image and a trace waveform with respect to another partial range on the time axis of the Doppler spectrum data in accordance with the operation input, and controls the display device to display the newly generated D-mode image, the selection step newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and the measurement step measures the diagnostic parameter with use of part of the newly generated trace waveform corresponding to the newly selected measurement target cardiac cycle period.

### ADVANTAGEOUS EFFECTS OF INVENTION

With the above configuration, even in the case where a D-mode image is frozen or even in the case where a D-mode image showing past cardiac cycles is cine-played back, the present invention allows measurement of various diagnostic parameters only with a simple operation. Therefore, it is possible to save an operator the trouble of performing various settings for measuring the various diagnostic parameters, thereby improving diagnostic efficiency.

### BRIEF DESCRIPTION OF DRAWINGS

FIG. 1 is a block diagram showing configuration of an ultrasound diagnostic device 100 relating to an embodiment.

FIG. 2 is a flow chart showing measurement operations of various diagnostic parameters performed in the case where a D-mode image that is displayed in real time is frozen in the ultrasound diagnostic device 100 relating to the embodiment.

FIG. 3 is a schematic view showing an example of a D-mode image that is displayed on a display device in the case where no operation input instructing to change a D-mode image to be displayed has been made in the ultrasound diagnostic device 100 relating to the embodiment.

FIG. 4 is a schematic view showing an example of a D-mode image that is displayed on the display device in the case where an operation input instructing to change a D-mode image to be displayed has been made in the ultrasound diagnostic device 100 relating to the embodiment.

FIG. 5 is a flow chart showing measurement operations of various diagnostic parameters with respect to a D-mode image that is cine-played back in the ultrasound diagnostic device 100 relating to the embodiment.

FIG. 6 is a schematic view showing an example of a D-mode image in Modification 1 of the ultrasound diagnostic device 100 relating to the embodiment.

FIG. 7 is a schematic view showing an example of a D-mode image in Modification 2 of the ultrasound diagnostic device 100 relating to the embodiment.

### Description of Embodiments

The following describes an ultrasound diagnostic device relating to an embodiment, a control method of the ultrasound diagnostic device, and a control circuit of the ultrasound diagnostic device, with reference to the drawings.

### Outline of Embodiment for the Present Invention

In order to achieve the above aim, an ultrasound diagnostic device that is connectable with a recording medium and a display device, the ultrasound diagnostic device comprising: an operation inputter that receives an operation input from a user; an image controller that reads Doppler spectrum data corresponding to a plurality of cardiac cycles that is recorded in the recording medium, generates a D-mode image and a trace waveform with respect to a partial range on a time axis of the Doppler spectrum data, and controls the display device to display part or all of the D-mode image; a cardiac cycle period selector that detects a plurality of cardiac cycle periods shown in the D-mode image from the trace waveform, and selects at least one cardiac cycle period from among the detected cardiac cycle periods as a measurement target cardiac cycle period according to a predetermined selection criterion; and a measure that measures a predetermined diagnostic parameter with use of part of the trace waveform corresponding to the measurement target cardiac cycle period, wherein when the operation inputter receives an operation input instructing to change a D-mode image to be displayed from the D-mode image that is displayed to another D-mode image, the image controller newly generates the other D-mode image and a trace waveform with respect to another partial range on the time axis of the Doppler spectrum data in accordance with the operation input, and controls the display device to display the newly generated D-mode image, the cardiac cycle period selector newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and the measure measures the diagnostic parameter with use of part of the newly generated trace waveform corresponding to the newly selected measurement target cardiac cycle period.

Also, according to another aspect of the present invention, the selection criterion may indicate that a temporally latest cardiac cycle period is selected as a measurement target cardiac cycle period from among a plurality of cardiac cycle periods shown in a D-mode image displayed on the display device.

Also, according to further another aspect of the present invention, the temporally latest cardiac cycle period may be a temporally latest time period among a plurality of time periods that are each a time period between two adjacent ones of a plurality of end diastoles shown in the displayed D-mode image.

Also, according to still another aspect of the present invention, the selection criterion may indicate that a temporally earliest cardiac cycle period is selected as a measurement target cardiac cycle period from among a plurality of cardiac cycle periods shown in a D-mode image displayed on the display device.

Also, according to yet another aspect of the present invention, the temporally latest cardiac cycle period may be a temporally earliest one of a plurality of time periods that are each a time period between two adjacent ones of a plurality of end diastoles shown in the displayed D-mode image.

Also, according to another aspect of the present invention, when the selection criterion indicates that at least one cardiac cycle period that is designated by the user from among a plurality of cardiac cycle periods shown in a D-mode image displayed on the display device is selected as a measurement target cardiac cycle period, the operation inputter may receive an operation input instructing to designate a measurement target range on the displayed D-mode image, the image controller may control the display device to display the measurement target range, and the cardiac cycle period selector may select at least one cardiac cycle period included in the measurement target range from among a plurality of cardiac cycle periods shown in the displayed D-mode image as a measurement target cardiac cycle period.

Also, according to further another aspect of the present invention, when the selection criterion indicates that at least one cardiac cycle period is selected from among a plurality of cardiac cycle periods shown in the displayed D-mode image as a measurement target cardiac cycle period according to a parameter, the parameter being selected from among PSV, an absolute value thereof, RI, PI, and a degree of reliability in trace waveform that are each obtained from a trace waveform corresponding to the displayed D-mode image, the measure may further measure the parameter with respect to each of the cardiac cycle periods shown in the displayed D-mode with use of the trace waveform, and the cardiac cycle period selector may select, as a measurement target cardiac cycle period, at least one cardiac cycle period with respect to which a measured value of the parameter is the most appropriate from among the cardiac cycle periods shown in the displayed D-mode image.

Also, according to still another aspect of the present invention, the image controller may control the display device to display a measurement target cardiac cycle period in a different manner from a remainder of a plurality of cardiac cycle periods shown in a D-mode image displayed on the display device.

Also, according to yet another aspect of the present invention, the cardiac cycle period selector may detect a plurality of cardiac cycle periods shown in a D-mode image that is displayed on the display device by detecting a plurality of end diastoles shown in the displayed D-mode image and defining a time period between each two adjacent ones of the end diastoles as one cardiac cycle period.

Also, according to another aspect of the present invention, the diagnostic parameter may be at least one selected from among PSV, EDV, TAMV, RI, and PI.

Also, according to further another aspect of the present invention, when the operation inputter receives an operation input instructing to perform a freeze operation for freezing a D-mode image that is displayed on the display device, the image controller may continue to display the D-mode image as of a time when the freeze operation has been performed, and the cardiac cycle period selector may select at least one cardiac cycle period from among a plurality of cardiac cycle periods shown in the displayed D-mode image as a measurement target cardiac cycle period according to the selection criterion.

Also, according to still another aspect of the present invention, the ultrasound diagnostic device may further comprise a D-mode image generator that generates Doppler spectrum data corresponding to a plurality of cardiac cycles from reception signals that are obtained through transmission and reception of an ultrasound wave aimed at the inside of a subject, and outputs the Doppler spectrum data to the recording medium.

Also, according to yet another aspect of the present invention, the measure may output measurement results of the diagnostic parameter to the image controller, and the image controller may control the display device to display the measurement results.

Also, according to another aspect of the present invention, an ultrasound diagnostic device that is connectable with a recording medium and a display device, the ultrasound diagnostic device comprising: an operation inputter that receives an operation input from a user; an image controller that reads reception signals corresponding to a plurality of cardiac cycles that are recorded in the recording medium, generates Doppler spectrum data with respect to a range corresponding to the reception signals, generates a D-mode image and a trace waveform with respect to a partial range on a time axis of the Doppler spectrum data, and controls the display device to display part or all of the D-mode image, the reception signals being obtained through transmission and reception of an ultrasound wave aimed at a blood vessel of a subject, the range being indicated by a sample gate that is set by the operation inputter; a cardiac cycle period selector that detects a plurality of cardiac cycle periods shown in the D-mode image from the trace waveform, and selects at least one cardiac cycle period from among the detected cardiac cycle periods as a measurement target cardiac cycle period according to a predetermined selection criterion; and a measure that measures a predetermined diagnostic parameter with use of part of the trace waveform corresponding to the measurement target cardiac cycle period, wherein when the operation inputter receives an operation input instructing to change a D-mode image to be displayed from the D-mode image that is displayed to another D-mode image, the image controller newly generates the other D-mode image and a trace waveform with respect to another partial range on the time axis of the Doppler spectrum data in accordance with the operation input, and controls the display device to display the newly generated D-mode image, the cardiac cycle period selector newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and the measure measures the diagnostic parameter with use of part of the newly generated trace waveform corresponding to the newly selected measurement target cardiac cycle period.

Also, a control method relating to further another aspect of the present invention is a control method of an ultrasound diagnostic device that is connectable with a recording medium and a display device, the control method comprising: a generation step of generating Doppler spectrum data corresponding to a plurality of cardiac cycles from reception signals that are obtained through transmission and reception of an ultrasound wave aimed at the inside of a subject; an operation input of receiving an operation input from a user; a recording step of recording the Doppler spectrum data in the recording medium; an image control step of reading the recorded Doppler spectrum data, generating a D-mode image and a trace waveform with respect to a partial range on a time axis of the Doppler spectrum data, and controlling the display device to display part or all of the D-mode image; a selection step of detecting a plurality of cardiac cycle periods shown in the D-mode image from the trace waveform, and selecting at least one cardiac cycle period from among the detected cardiac cycle periods as a measurement target cardiac cycle period according to a predetermined selection criterion; and a measurement step of measuring a predetermined diagnostic parameter with use of part of the trace waveform corresponding to the measurement target cardiac cycle period, wherein when the operation input step receives an operation input instructing to change a D-mode image to be displayed from the D-mode image that is displayed to another D-mode image, the generation step newly generates the other D-mode image and a trace waveform with respect to another partial range on the time axis of the Doppler spectrum data in accordance with the operation input, and controls the display device to display the newly generated D-mode image, the selection step newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and the measurement step measures the diagnostic parameter with use of part of the newly generated trace waveform corresponding to the newly selected measurement target cardiac cycle period.

### Embodiment

The following describes an ultrasound diagnostic device 100 relating to an embodiment, a control method of the ultrasound diagnostic device 100, and a control circuit 1 of the ultrasound diagnostic device 100, with reference to the drawings.

### Configuration

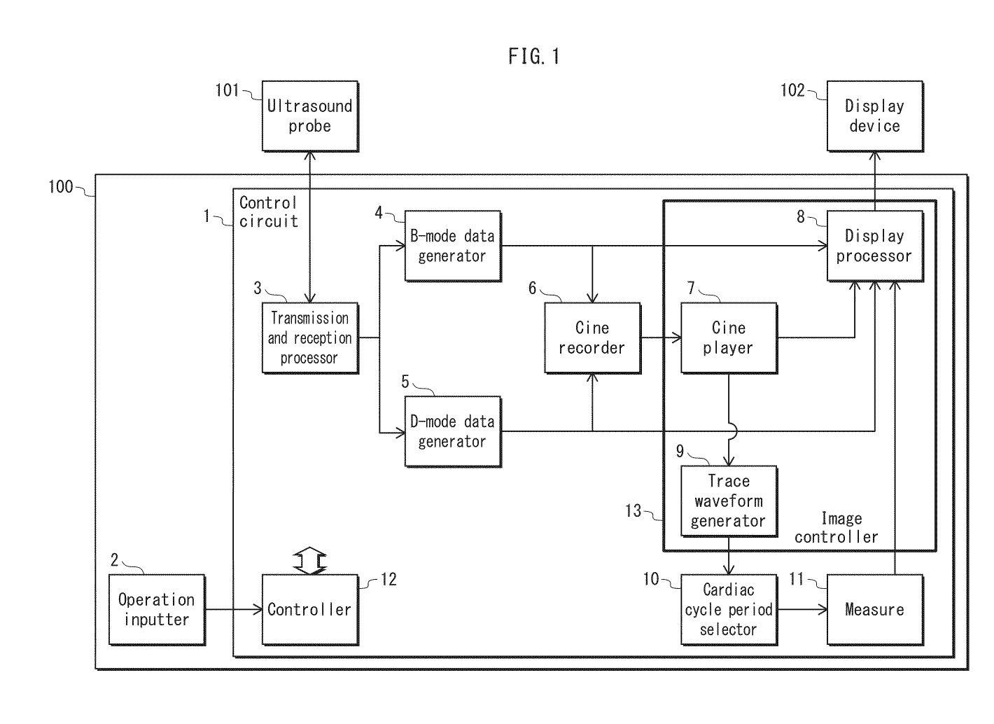

FIG. 1 is a block diagram showing functional configuration of the ultrasound diagnostic device 100 relating to the present embodiment.

As shown in FIG. 1, the ultrasound diagnostic device 100 includes an operation inputter 2 and the control circuit 1. Blocks constituting the control circuit 1 are described later. Also, the ultrasound diagnostic device 100 is configured to be connectable with an ultrasound probe 101 that transmits and receives an ultrasound aimed at a subject, and with a display device 102. FIG. 1 shows a state where the ultrasound probe 101 and the display device 102 are each connected with the ultrasound diagnostic device 100.

(Ultrasound Probe 101)

The ultrasound probe 101 has a transducer array in which a plurality of piezoelectric elements are arranged into multiple columns. The ultrasound probe 101 receives a transmission signal that is a pulse or continuous electrical signal supplied from a transmission and reception processor 3 which is described later, and converts the transmission signal into a pulse or continuous ultrasound wave. While the transducer array is in contact with skin surface of the subject, the ultrasound probe 101 transmits ultrasound beams from the skin surface toward tissue of the subject including a blood vessel. After that, the ultrasound probe 101 receives an ultrasound echo signal that is a reflected ultrasound wave from the subject, and converts the ultrasound echo signal into an electrical signal by the piezoelectric elements, and supplies the electrical signal to the transmission and reception processor 3. In this way, the transmission and reception processor 3 acquires a reception signal for generating a B-mode image and a D-mode image of the blood vessel.

(Operation Inputter 2)

The operation inputter 2 receives an operation input of various settings, operations, and so on from an operator made on the ultrasound diagnostic device 100, and outputs the operation input to the controller 12.

The operation inputter 2 may be for example integrated with the display device 102 as a touch panel. In this case, the ultrasound diagnostic device 100 can be operated using the touch panel by performing a touch operation, a drag operation, and so on on an operation key displayed on the display device 102, in order to make various settings and operations on the ultrasound diagnostic device 100. Alternatively, the operation inputter 2 may be for example a keyboard that has keys for performing various operations, or an operation panel that has buttons, levers, or the like for performing various operations. Further alternatively, the operation inputter 2 may be a trackball, a mouse, a flat pad, or any other equipment for moving a cursor displayed on the display device 102. Yet alternatively, the operation inputter 2 may be a plurality of any of the above equipment, or may be a combination of different types of the above equipment.

(Control Circuit 1)

The control circuit 1 controls the operations of the ultrasound diagnostic device 100 in accordance with an operation input from the operation inputter 2. The control circuit 1 includes the transmission and reception processor 3, a B-mode data generator 4, a D-mode data generator 5, and a cine recorder 6 that is a recording medium. Also, the control circuit 1 further includes an image controller 13 that includes a cine player 7, a display processor 8, and a trace waveform generator 9. Moreover, the control circuit 1 further includes a cardiac cycle period selector 10 and a measure 11. These blocks are each controlled by the controller 12. The transmission and reception processor 3 is connected with the ultrasound probe 101. The display processor 8 is connected with the display device 102. The following describes the configuration of the blocks.

(Transmission and Reception Processor 3)

The transmission and reception processor 3 performs transmission processing of causing the ultrasound probe 101 to transmit ultrasound beams and reception processing of generating a reception signal based on a reflected ultrasound wave received by the ultrasound probe 101. In other words, the transmission and reception processor 3 performs processing of generating a transmission control signal for causing the ultrasound probe 101 to transmit ultrasound beams, and supplying a transmission electrical signal of high voltage, which occurs in accordance with a predetermined timing, to the ultrasound probe 101 based on the transmission control signal, thereby to drive the piezoelectric elements included in the ultrasound probe 101. Hereinafter, this processing is referred to as transmission processing. By performing this transmission processing, the ultrasound probe 101 converts the transmission electrical signal to an ultrasound wave, and transmits ultrasound beams toward a subject that is a measurement target.

Also, the transmission and reception processor 3 performs generation processing of a reception signal by amplifying and A/D converting a reception electrical signal, which is obtained by converting a reflected ultrasound wave from the subject by the ultrasound probe 101. Hereinafter, this processing is referred to as reception processing. The reception signal is, for example, made up of a plurality of signals obtained in a direction along the transducer array and in a depth direction of the subject away from the transducer array. These signals are each a digital signal obtained by A/D converting an electronic signal which is converted in accordance with the amplitude of the reflected ultrasound wave. The reception signal is supplied to the B-mode data generator 4 and the D-mode data generator 5.

(B-mode Data Generator 4)

The B-mode data generator 4 generates B-mode frame data from the reception signal as source data of a B-mode image showing a tomographic image within a living organism. The B-mode data generator 4 can have the same configuration as for example a known ultrasound diagnostic device that is disclosed in Japanese Patent Application Publication No. 2005-40598 and the like.

Specifically, the B-mode data generator 4 analyzes the amplitude of the reception signal to convert the reception signal to a brightness signal in accordance with the amplitude. After that, the B-mode data generator 4 generates B-mode frame data corresponding to one frame from a brightness signal that is converted from a reception signal corresponding to one frame that is obtained in the direction along the transducer array and in the depth direction away from the transducer array. The B-mode frame data corresponding to a plurality of frames is generated from reception signals that are obtained within a predetermined temporally continuous period. The B-mode frame data is output to the cine recorder 6 and the display processor 8. The B-mode frame data is a signal corresponding to polar coordinates of a scan plane of the ultrasound probe 101, as well as the reception signal.

(D-Mode Data Generator 5)

The D-mode data generator 5 generates Doppler spectrum data from the reception signals as source data of a D-mode image showing temporal variation in blood flow within the living body. The D-mode data generator 5 may have the same configuration as for example the known ultrasound diagnostic device that is disclosed in Japanese Patent Application Publication No. 2005-40598 and the like.

Specifically, the D-mode data generator 5 performs quadrature detection on each of reception signals corresponding to a range indicated by a sample gate set at a desired position on a B-mode image input from the operation inputter 2, with use of a reference signal at a frequency substantially the same as a resonance frequency of the piezoelectric elements. After that, the D-mode data generator 5 performs FFT frequency analysis on a Doppler signal obtained by the quadrature detection, and as a result Doppler spectrum data is obtained. The Doppler spectrum data is generated from reception signals that are obtained within a predetermined temporally continuous period. Accordingly, the Doppler spectrum data is normally generated from reception signals obtained within a period corresponding to a plurality of cardiac cycles. The Doppler spectrum data is output to the cine recorder 6 for recording. Also, the Doppler spectrum data is supplied to the display processor 8, and D-mode images are successively generated for display on the display device 102 as described later.

Here, the number of sample gates set on the B-mode image may be single or plural. In the case where a plurality of sample gates are set, a plurality of pieces of Doppler spectrum data that correspond in number to the sample gates are generated. Also, the size of the range indicated by the sample gate may be changeable by the operator.

(Cine Recorder 6)

The cine recorder 6 is a recording medium that successively records therein generated B-mode frame data and corresponding Doppler spectrum data. The cine recorder 6 may associate the B-mode frame data with the corresponding Doppler spectrum data, and after that, successively record therein the associated B-mode frame data and Doppler spectrum data. One unit of B-mode frame data is composed of pieces of B-mode frame data corresponding to a plurality of frames generated from reception signals obtained within a predetermined temporally continuous period. One unit of Doppler spectrum data is generated from reception signals obtained within a predetermined temporally continuous period.

After that, the cine recorder 6 supplies the B-mode frame data and the corresponding Doppler spectrum data to the cine player 7 in accordance with an operation input from the operator made on the operation inputter 2.

(Cine Player 7)

The cine player 7 performs playback processing of B-mode frame data and corresponding Doppler spectrum data, which are recorded in the cine recorder 6, via an instruction issued by the controller 12 based on an operation input from the operation inputter 2. In this playback processing, the cine player 7 reads the B-mode frame data and the corresponding Doppler spectrum data, which are recorded in the cine recorder 6, and outputs the B-mode frame data and Doppler spectrum data to the display processor 8. At this time, the operator operates the operation inputter 2 thereby to perform, on a D-mode image, which undergoes display processing performed by the display processor 8 described later and is displayed on the display device 102, normal playback processing for playback at a normal speed, fast-forward processing for fast-forwarding, and fast-rewind processing for fast-rewinding.

Also, the cine player 7 supplies the Doppler spectrum data, which is the playback processing target, to the trace waveform generator 9 at the same time.

(Display Processor 8)

The display processor 8 performs processing of generating a B-mode image from B-mode frame data, generating a D-mode image from Doppler spectrum data, and controlling the display device 102 to display the generated B-mode image and D-mode image.

The B-mode image indicates an image of one frame displayed on the display screen of the display device 102.

Also, the D-mode image indicates an image of one frame displayed on the display screen of the display device 102.

Furthermore, the display processor 8 controls the display device 102 to display an image expressing a trace waveform generated by the trace waveform generator 9, which is described later. Moreover, the display processor 8 controls the display device 102 to display measurement results of various diagnostic parameters measured by the measure 11 with use of the trace waveform.

In order to display a B-mode image, the display processor 8 generates a B-mode image mainly by performing coordinate conversion on brightness signals of B-mode frame data so as to correspond to orthogonal coordinate systems. After that, the display processor 8 outputs the generated B-mode image to the display device 102, and the B-mode image is displayed on the display device 102.

In order to display a D-mode image, the display processor 8 generates a temporally continuous D-mode image showing Doppler spectrum data in which power (intensity) of flow velocity (frequency) components is plotted as brightness (gradation) with time (t) on the horizontal axis and flow velocity (V) corresponding to frequency on the vertical axis. After that, the display processor 8 outputs the generated D-mode image to the display device 102, and the D-mode image is displayed on the display device 102.

In order to display, on the display device 102, an image generated from reception signals that are acquired while the transmission and reception processing is performed by the transmission and reception processor 3 (hereinafter, referred to as real-time display or display in real time), the display processor 8 acquires B-mode frame data and Doppler spectrum data from the B-mode data generator 4 and the D-mode data generator 5, respectively. In the case where a D-mode image is displayed in real time, the display processor 8 can control the display device 102 to display the D-mode image simultaneously with a corresponding B-mode image and an image indicating a position of a sample gate set on the B-mode image (hereinafter, referred to as sample gate image).

On the other hand, in order to perform cine playback processing of displaying B-mode frame data and corresponding Doppler spectrum data, which are recorded in the cine recorder 6, the display processor 8 acquires the B-mode frame data and the Doppler spectrum data from the cine player 7. In the case where cine playback processing is performed, the display processor 8 can similarly control the display device 102 to display a D-mode image simultaneously with a corresponding B-mode image and a sample gate image which is described later.

Also, in the case where the operator performs an operation for freezing a D-mode image that is displayed in real time (hereinafter, referred to as freeze operation) on the operation inputter 2 in accordance with a desired timing, the display processor 8 performs freeze processing of continuously displaying the D-mode image as of a time when the freeze operation has been performed.

In the case where the freeze operation is performed during real-time display, the display processor 8 switches an acquisition destination of B-mode frame data from the B-mode data generator 4 to the cine player 7. After that, the display processor 8 generates a B-mode image from the B-mode frame data which is acquired from the cine player 7, and controls the display device 102 to display the B-mode image.

Similarly, the display processor 8 switches an acquisition destination of Doppler spectrum data from the D-mode data generator 5 to the cine player 7. After that, the display processor 8 generates a D-mode image from the D-mode image which is acquired from the cine player 7, and controls the display device 102 to display the D-mode image.

(Trace Waveform Generator 9)

When a D-mode image that is displayed in real time is frozen or when cine playback of Doppler spectrum data is performed to display a D-mode image, the trace waveform generator 9 acquires Doppler spectrum data from the cine player 7, and generates a trace waveform of the Doppler spectrum data. The trace waveform is generated with respect to a partial range on the time axis of Doppler spectrum data from which a D-mode image is generated which is displayed simultaneously with the trace waveform on the display screen of the display device 102 controlled by the display processor 8. A new trace waveform is successively generated in synchronization with generation of a new D-mode image performed over time by the display processor 8.

The trace waveform is generated for example by extracting a point of the maximum flow velocity and a point of the average flow velocity of the Doppler spectrum data for each time and connecting the extracted points. The trace waveform can be for example generated by a known method which is disclosed in Japanese Patent Application Publication No. 2003-284718, Japanese Patent Application Publication No. 2005-81081, and the like. The generated trace waveform is output to the cardiac cycle period selector 10.

(Cardiac Cycle Period Selector 10)

The cardiac cycle period selector 10 detects, from the trace waveform, a plurality of cardiac cycle periods shown in a D-mode image which is displayed on the display device 102, and selects at least one cardiac cycle period as a measurement target cardiac cycle period according to a predetermined selection criterion. In other words, the cardiac cycle period selector 10 detects an end diastole of each cardiac cycle from the trace waveform corresponding to the D-mode image which is displayed on the display device 102. After that, the cardiac cycle period selector 10 detects a plurality of cardiac cycle periods by defining a time period between each two adjacent ones of the end diastoles corresponding to the trace waveform as one cardiac cycle period. The cardiac cycle period selector 10 detects a plurality of cardiac cycle periods corresponding to the whole trace waveform corresponding to the D-mode image which are simultaneously displayed on the display device 102. In this way, all the cardiac cycle periods corresponding to the whole trace waveform are detected.

Specifically, the cardiac cycle period selector 10 for example detects, as a first end diastole, the temporally earliest end diastole from the trace waveform corresponding to a D-mode image that is displayed on the display device 102, and sets, as one cardiac cycle, a time period from a time immediately after the first end diastole to a next end diastole (a second end diastole) that is temporally continuous from the first end diastole. Furthermore, the cardiac cycle period selector 10 sets, as one cardiac cycle, a time period from a time immediately after the second end diastole to a next end diastole (a third end diastole) that is temporally continuous from the second end diastole. After that, the cardiac cycle period selector 10 performs such processing of setting one cardiac cycle until the temporally latest end diastole is detected from the trace waveform corresponding to the D-mode image which is displayed on the display device 102. The cardiac cycle period selector 10 defines, as one cardiac cycle period, a time period between each two adjacent ones of all the end diastoles corresponding to the trace waveform corresponding to the D-mode image which is displayed on the display device 102.

The cardiac cycle period selector 10 selects, as a measurement target cardiac cycle period that is to be measured by the measure 11, a cardiac cycle period that satisfies the selection criterion that has been determined therein beforehand from among the cardiac cycle periods. The selection criterion to be set can indicate that the temporally latest cardiac cycle period, the temporally earliest cardiac cycle period, a cardiac cycle period that is positioned midway between the temporally latest cardiac cycle period and the temporally earliest cardiac cycle period, or the like is selected from among a plurality of cardiac cycle periods corresponding to a trace waveform corresponding to a D-mode image that are simultaneously displayed on the display device 102. Alternatively, the selection criterion may be selected via an operation input made by the operator on the operation inputter 2 by displaying these selection criteria on the display device 102.

Note that the cardiac cycle period selector 10 does not necessarily need to select one cardiac cycle period as a measurement target cardiac cycle period, and alternatively may select two or more temporally continuous cardiac cycle periods.

After that, the cardiac cycle period selector 10 outputs a partial trace waveform corresponding to the measurement target cardiac cycle period, which is selected according to the selection criterion, to the measure 11.

(Measure 11)

The measure 11 measures various diagnostic parameters with use of a partial trace waveform corresponding to a measurement target cardiac cycle period.

The various diagnostic parameters include for example peak systolic velocity (PSV), end diastolic velocity (EDV), time average maximum velocity (TAMV), resistance index (RI), pulsatility index (PI), and the like. It is possible to diagnose stenosis of a blood vessel by measuring PSV, EDV, RI, and/or PI. However, a diagnostic parameter to be measured by the measure 11 does not necessarily need to be the above various diagnostic parameters. Alternatively, the measure 11 may measure other diagnostic parameters.

The measure 11 outputs measurement results of various diagnostic parameters, which are measured with use of the trace waveform, to the display processor 8.

(Controller 12)

The controller 12 controls the blocks constituting the control circuit 1 in accordance with an instruction issued by the operation inputter 2. The controller 12 can be embodied by a processor such as a CPU.

### Operations The following describes the operations of the ultrasound diagnostic device 100 having the above configuration, with reference to flow charts.

(Measurement of Various Diagnostic Parameters Performed in the Case Where D-Mode Image that is Displayed in Real Time is Frozen)

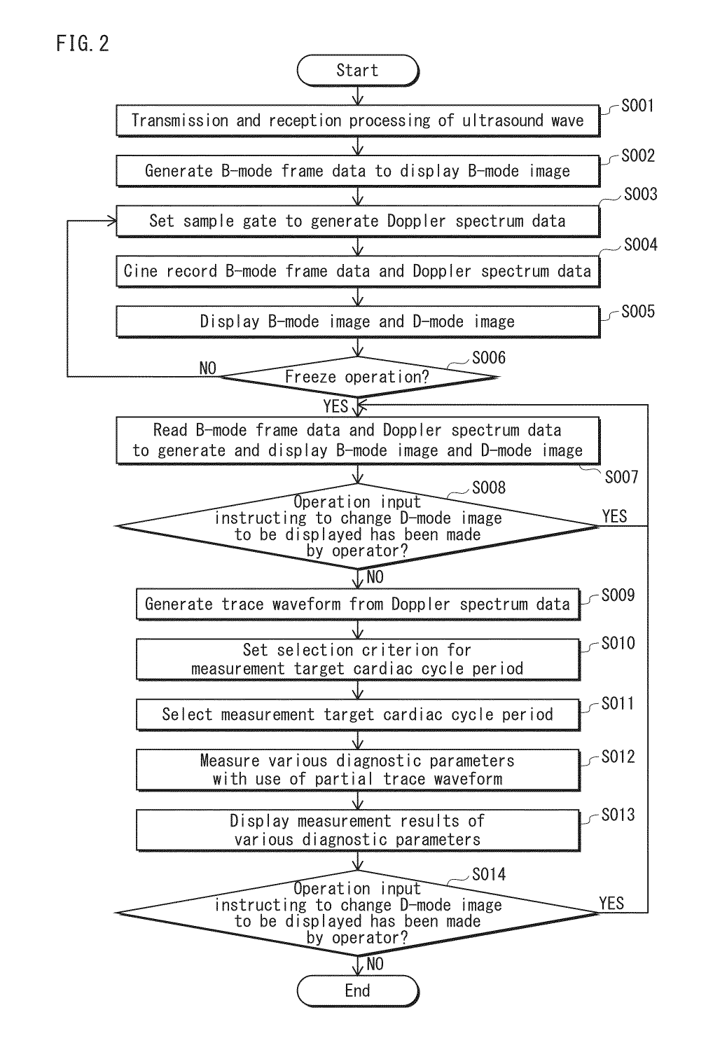

Description is given on measurement operations of various diagnostic parameters performed in the case where a D-mode image that is displayed in real time is frozen. FIG. 2 is a flow chart showing measurement operations of the various diagnostic parameters performed in the case where a D-mode image which is displayed in real time is frozen in the ultrasound diagnostic device 100 relating to the present embodiment. This flow chart shows a control method of the ultrasound diagnostic device 100, including an operation input from an operator.

### Step 1 (S001)

Step 1 (S001) is a step in which the transmission and reception processor 3 performs transmission processing and reception processing of an ultrasound wave on the ultrasound probe 101.

In this step, while the transmission and reception processor 3 performs transmission processing on the ultrasound probe 101, that is, drives the ultrasound probe 101, the operator applies the ultrasound probe 101 against a skin surface of a subject. This results in transmission of ultrasound beams from the ultrasound probe 101 toward the inward of the subject. After that, the ultrasound probe 101 receives a reflected ultrasound wave which is reflected within the subject via the piezoelectric elements included therein, and converts the reflected ultrasound wave to an electrical signal. Upon receiving the electrical signal, the transmission and reception processor 3 generates a reception signal.

### Step 2 (S002)

Step 2 (S002) is a step in which a B-mode image is displayed on the display device 102.

The B-mode data generator 4 generates B-mode frame data mainly by analyzing the amplitude of the reception signals, which are generated by the transmission and reception processor 3. Here, the B-mode image is generated from B-mode frame data corresponding to one frame, and new B-mode images are successively generated over time, as described above. After that, the display processor 8 converts the B-mode frame data to B-mode image data, and controls the display device 102 to display a B-mode image on the display region for B-mode image.

### Step 3 (S003)

Step 3 (S003) is a step in which the operator sets a sample gate based on the B-mode image displayed on the display device 102, and generates Doppler spectrum data based on the sample gate.

First, the display processor 8 performs processing of superposing and displaying a sample gate image, which indicates a position of the sample gate, on a predetermined initial position on the B-mode image displayed on the display device 102. The operator for example operates an operation key for sample gate setting included in the operation inputter 2. The operator operates the operation inputter 2 to move the sample gate image to a desired position on the B-mode image, and sets the sample gate at the desired position. When the sample gate is set at the desired position on the B-mode image, the D-mode data generator 5 performs quadrature detection on reception signals corresponding to a range indicated by the sample gate with use of a reference signal of a frequency substantially the same as a resonance frequency of the piezoelectric elements, and performing frequency analysis on the reception signals by FFT. As a result, Doppler spectrum data is obtained. As described above, the Doppler spectrum data is generated based on reception signals which are obtained within a predetermined temporally continuous period corresponding to a plurality of cardiac cycles.

### Step 4 (S004)

Step 4 S004 is a step in which B-mode frame data and corresponding Doppler spectrum data are successively recorded. The cine recorder 6 associates the B-mode frame data with the corresponding Doppler spectrum data, and successively records therein the associated B-mode frame data and Doppler spectrum data. Here, as described above, one unit of B-mode frame data is composed of pieces of B-mode frame data corresponding to a plurality of frames generated from reception signals obtained within a predetermined temporally continuous period, and one unit of Doppler spectrum data is similarly generated from reception signals obtained within a predetermined temporally continuous period.

### Step 5 (S002)

Step 5 (S002) is a step in which a B-mode image and a D-mode image are displayed on the display device 102.

When the operator for example operates an operation key for D-mode image display included in the operation inputter 2, the display processor 8 divides the display region for B-mode image of the display screen into two regions for example up and down (or right and left) to set the upper region as a display region for B-mode image and the lower region as a display region for D-mode image. After that, the display processor 8 generates a B-mode image and a D-mode image respectively from B-mode frame data and corresponding Doppler spectrum data, which are successively supplied from the B-mode data generator 4 and the D-mode data generator 5, respectively. The display processor 8 allocates the B-mode image and the D-mode image to the respective display regions of the display screen, and controls the display device 102 to display the B-mode image and the D-mode image.

As a result, the display device 102 displays the D-mode image showing a spectral display of temporally continuous Doppler spectrum data corresponding to a plurality of heartbeats in which power (intensity) of flow velocity (frequency) components is plotted as brightness (gradation) with time (t) on the horizontal axis and flow velocity (V) corresponding to frequency on the vertical axis. Each time Doppler spectrum data corresponding to every plurality of cardiac cycles is updated, a new D-mode image is successively generated and displayed.

Also, the display device 102 similarly displays a B-mode image corresponding to the Doppler spectrum data displayed as the D-mode image.

### Step 6 (S006)

Step 6 (S006) is a step of a freeze operation is performed on a D-mode image.

The operator performs a freeze operation by for example operating an operation key for freeze included in the operation inputter 2 in accordance with a desired timing while watching the D-mode image which is displayed on the display device 102. Upon receiving the instruction, the display processor 8 freezes (stops updating) the D-mode image, which is successively updated and displayed for every plurality of cardiac cycles. In other words, in the case where the operator performs a freeze operation on the D-mode image which is displayed in real time (“Yes” in FIG. 2), the display processor 8 performs freeze processing of continuously displaying the D-mode image as of a time when the freeze operation has been performed, and the flow proceeds to Step 7 (S007).

In the case where no freeze operation is performed on the contrary (“No” in FIG. 2), the flow returns to Step 3 (S003), and processing of Step 3 (S003), Step 4 (S004), and Step 5 (S005) is performed.

### Step 7 (S007)

Step 7 (S007) is a step in which, in accordance with the freeze operation, the cine player 7 reads B-mode frame data as of a time when the freeze operation has been performed and corresponding Doppler spectrum data from the cine recorder 6, outputs the B-mode frame data and Doppler spectrum data to the display processor 8, and the display processor 8 controls the display device 102 to display a B-mode image and a D-mode image. In other words, as described above, in the case where the freeze operation is performed on the D-mode image which is displayed in real time, the display processor 8 switches the acquisition destination of B-mode frame data from the B-mode data generator 4 to the cine player 7. After that, the display processor 8 generates a B-mode image from B-mode frame data which is acquired from the cine player 7, and controls the display device 102 to display the B-mode image. Similarly, the display processor 8 switches the acquisition destination of Doppler spectrum data from the D-mode data generator 5 to the cine player 7 after the freeze operation. After that, the display processor 8 generates a D-mode image from Doppler spectrum data which is acquired from the cine player 7, and controls the display device 102 to display the D-mode image.

### Step 8 (S008)

Step 8 (S008) is a step in which the controller 12 judges whether an operation input instructing to change a D-mode image to be displayed has been made by the operator on the operation inputter 2. Change of a D-mode image to be displayed indicates to move, along the time (t) on the horizontal axis, Doppler spectrum data displayed as a spectrum corresponding to a plurality of temporally continuous cardiac cycles.

The operation inputter 2 may be for example integrated with the display 102 as a touch panel, as described above. In this case, the Doppler spectrum data displayed as a spectrum can be moved by performing a touch operation, a drag operation, and so on on an operation key displayed on the display device 102. Also, in the case where the operation inputter 2 is for example a trackball, a mouse, a flat pad, or the like for moving the cursor displayed on the display device 102, the

Doppler spectrum data displayed as a spectrum can be also moved by designating a position of the spectral display by the cursor to perform a drag operation.

The controller 12 judges whether an operation input instructing to change a D-mode image to be displayed such as described above has been made by the operator on the operation inputter 2 within a predetermined period such as two to three seconds.

(A-1) Case Where Operation Input Instructing to Change D-Mode Image to be Displayed Has Been Made Within Predetermined Period

In the case where an operation input instructing to change a D-mode image to be displayed has been made within the predetermined period (“Yes” in FIG. 2), the flow proceeds to Step 7.

As described above, the B-mode image and the D-mode image, which are respectively generated from the B-mode frame data as of the time when the freeze operation has been performed and the corresponding Doppler spectrum data in Step 6, are displayed on the display device 102. Accordingly, the operator first moves the Doppler spectrum data displayed as a spectrum, in the backward direction along the time (t) on the horizontal axis. After that, the operator moves the Doppler spectrum data displayed as a spectrum in the forward direction along the time (t) on the horizontal axis, thereby to restore the Doppler spectrum data displayed as a spectrum to the state at the time when the freeze operation has been performed. In this way, the operator can scroll the Doppler spectrum data displayed as a spectrum, which is to be displayed within the predetermined period, in the forward and backward directions along the time (t) on the horizontal axis. In the case where no new operation input has been made within the predetermined period, the flow proceeds to Step 7 (S007).

(A-2) Step 7 (S007) Subsequent to Step 8 (S008)

Step 7 (S007) subsequent to Step 8 (S008) is a step in which, in accordance with an operation input instructing to change a D-mode image to be displayed has been made, a D-mode image is newly generated with respect to another partial range on the time axis of the Doppler spectrum data displayed on the display device 102, and the newly generated D-mode image is displayed on the display device 102.

First, the cine player 7 shifts the partial range on the time axis of the Doppler spectrum data to be read from the cine recorder 6 in accordance with the operation input. Specifically, in accordance with the operation input, the cine player 7 shifts the partial range on the time axis of the Doppler spectrum data that is to be read, and reads the shifted partial range on the time axis of the Doppler spectrum data. The cine player 7 also reads B-mode frame data corresponding to the shifted partial range. After that, the cine player 7 outputs the newly read partial range on the time axis of the Doppler spectrum data and corresponding B-mode frame data to the display processor 8. The display processor 8 controls the display device 102 to display a B-mode image and a D-mode image. After that, the flow proceeds to Step 8 (S008).

(B) Case Where No Operation Input Has Been Made Within Predetermined Period

In the case where no operation input has been made within the predetermined period (“No” in FIG. 2), the flow proceeds to Step 9 (S009).

### Step 9 (S009)

Step 9 (S009) is a step in which the trace waveform generator 9 generates a trace waveform of the Doppler spectrum data read by the trace waveform generator 9 in Step 7 (S007). As described above, the trace waveform is generated with respect to a partial range on the time axis of Doppler spectrum data from which a D-mode image is generated which is displayed simultaneously with the trace waveform on the display screen of the display device 102 controlled by the display processor 8. A new trace waveform is successively generated in synchronization with generation of a new D-mode image performed over time by the display processor 8. Here, as described above, the trace waveform is generated for example by connecting a point of the maximum flow velocity and a point of the average flow velocity of the Doppler spectrum data for each time.

### Step 10 (S010)

Step 10 (S010) is a step in which the cardiac cycle period selector 10 sets a selection criterion for a measurement target cardiac cycle period. The cardiac cycle period selector 10 sets the selection criterion. The selection criterion is for selecting a measurement target cardiac cycle period with respect to which various diagnostic parameters are to be measured, from among a plurality of cardiac cycle periods corresponding to a trace waveform corresponding to a D-mode image that are simultaneously displayed on the display device 102. The selection criterion may be set beforehand in a storage region of the cardiac cycle period selector 10. The measurement target cardiac cycle period is selected according to a temporal condition for a plurality of cardiac cycle periods corresponding to a trace waveform which corresponds to the D-mode image displayed on the display device 102. As described above, the selection criterion may for example indicate that the temporally latest cardiac cycle period, the temporally earliest cardiac cycle period, or the like is selected from among the cardiac cycle periods corresponding to the trace waveform corresponding to the D-mode image which are simultaneously displayed on the display device 102. Alternatively, the selection criterion may be selected via an operation input made by the operator on the operation inputter 2 by displaying a plurality of selection criteria, auxiliary information for selecting one of the selection criteria, and so on on the display device 102.

In the present embodiment, a selection criterion is set that for example indicates that the temporally latest cardiac cycle period is selected from among a plurality of cardiac cycle periods corresponding to a trace waveform corresponding to a D-mode image which are simultaneously displayed on the display device 102.

### Step 11 (S011)

Step 11 (S011) is a step in which the cardiac cycle period selector 10 selects a measurement target cardiac cycle period with respect to which various diagnostic parameters are to be measured in Step 12 (S012) which is described later, with use of a trace waveform corresponding to a plurality of cardiac cycle periods shown in the D-mode image which is generated from the Doppler spectrum data read in Step 7 (S007) and is displayed on the display device 102.

As a first procedure, the cardiac cycle period selector 10 detects, from the trace waveform, the cardiac cycle periods shown in the D-mode image which is displayed on the display device 102. As a second procedure, the cardiac cycle period selector 10 selects at least one cardiac cycle period as a measurement target cardiac cycle period according to the predetermined selection criterion set in Step 10 (S010).

In the first procedure, the cardiac cycle period selector 10 detects an end diastole of each of the cardiac cycles from the trace waveform corresponding to the D-mode image which is displayed on the display device 102. After that, the cardiac cycle period selector 10 defines a time period between each two adjacent ones of the end diastoles corresponding to the trace waveform as one cardiac cycle period, and detects all of a plurality of cardiac cycle periods corresponding to the trace waveform corresponding to the D-mode image which are simultaneously displayed on the display device 102. In the second procedure, the cardiac cycle period selector 10 selects, as a measurement target cardiac cycle period, a cardiac cycle period that satisfies the selection criterion that has been determined therein beforehand from among the cardiac cycle periods.

In the present embodiment, the selection criterion indicating that the temporally latest one cardiac cycle period is selected is shown as an example where the measurement target cardiac cycle period is selected according to a temporal condition for a plurality of cardiac cycle periods corresponding to a trace waveform corresponding to a D-mode image which is displayed on the display device 102.

(A) Case Where No Operation Input Instructing to Change D-Mode Image to Be Displayed Has Been Made

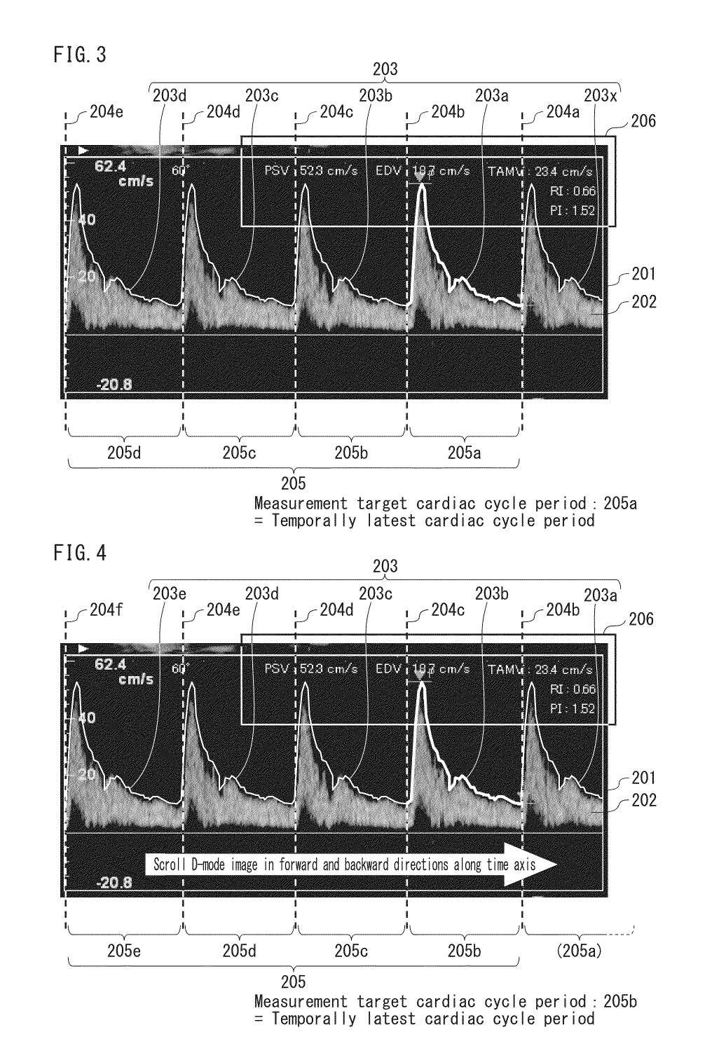

Description is given on operations of Step 11 (S011) that are performed in the case where no operation input instructing to change a D-mode image to be displayed has been made in Step 8 (S008) or Step 14 (S014) which is described later. FIG. 3 is a schematic view showing an example of a D-mode image that is displayed on the display device 102 in the case where no operation input instructing to change a D-mode image to be displayed has been made in the ultrasound diagnostic device 100 relating to the present embodiment. In the example, a D-mode image 201 is displayed on the display region for D-mode image of the display screen of the display device 102.

The D-mode image 201 shows a spectral display of temporally continuous Doppler spectrum data 202 corresponding to a plurality of heartbeats in which power (intensity) of flow velocity (frequency) components is plotted as brightness (gradation) with time (t) on the horizontal axis and flow velocity (V) corresponding to frequency on the vertical axis. In FIG. 3, a part positioned more rightward on the horizontal axis in the Doppler spectrum data 202 is temporally later. It is found that a freeze operation has been performed at a time (t) corresponding to a position at the rightmost position on the horizontal axis. Also, a trace waveform 203 of the Doppler spectrum data 202 is superposed and displayed on the D-mode image 201.

In the D-mode image 201, dashed lines 204a, 204b, 204c, 204d, and 204e each represent an end diastole that is detected from the trace waveform 203, and time periods 205a, 205b, 205c, and 205d between each two adjacent end diastoles each represent a cardiac cycle period. The D-mode image 201 in FIG. 3 shows the four cardiac cycle periods 205a, 205b, 205c, and 205d. A region on the right side of the cardiac cycle period 205a represents a time period that is shorter than one cardiac cycle. The trace waveform 203 is constituted from partial trace waveforms 203a, 203b, 203c, and 203d, which respectively correspond to the cardiac cycle periods 205a, 205b, 205c, and 205d, and a part 203x that is positioned on the right side of the end diastole 204a.

In the present embodiment as described above, the selection criterion is set that indicates that the temporally latest one cardiac cycle period is selected as a measurement target cardiac cycle period. In this case, the cardiac cycle period 205a, which is positioned at the rightmost position, is selected as the measurement target cardiac cycle period from among the four cardiac cycle periods 205a, 205b, 205c, and 205d shown in the D-mode image 201 displayed on the display device 102.

In this way, it is often the case that the rightmost region which is the temporally latest in the D-mode image 201 of the Doppler spectrum data 202 displayed as a spectrum shown in FIG. 3 represents only a time period corresponding to part of one cardiac cycle period. The temporally latest cardiac cycle period in this case is a time period between the end diastole 204a, which is positioned on the left side in the rightmost region displayed as a spectrum in the Doppler spectrum data 202, and the end diastole 204b, which is positioned on the left side of the end diastole 204a.

The cardiac cycle period selector 10 outputs the partial trace waveform 203a, which corresponds to the cardiac cycle period 205a selected as the measurement target cardiac cycle period, to the measure 11. Alternatively, the cardiac cycle period selector 10 may output the whole trace waveform 203 to the measure 11.

Also, as shown in FIG. 3 for example, the partial trace waveform 203a, which corresponds to the cardiac cycle period 205a selected as the measurement target cardiac cycle period, may be highlighted compared with the partial trace waveforms 203b, 203c, and 203d which respectively correspond to other cardiac cycle periods 205b, 205c, and 205d. Alternatively, only the partial trace waveform 203a, which corresponds to the cardiac cycle period 205a selected as the measurement target cardiac cycle period, may be displayed while the other partial trace waveforms 203b, 203c, and 203d, which respectively correspond to the other cardiac cycle periods 205b, 205c, and 205d, are not displayed.

(B) Case Where Operation Input Instructing to Change D-Mode Image to be Displayed Has Been Made

Description is given on operations of Step 11 (S011) that are performed in the case where an operation input instructing to change a D-mode image to be displayed has been made in Step 8 (S008) and Step 14 (S014) which is described later.

FIG. 4 is a schematic view showing an example of a D-mode image that is displayed on the display device 102 in the case where an operation input instructing to change a D-mode image to be displayed has been made in the ultrasound diagnostic device 100 relating to the present embodiment. In the example, the D-mode image 201 is displayed on the display region for D-mode image of the display screen of the display device 102. FIG. 4 shows the state in which the

Doppler spectrum data 202 displayed as a spectrum on the display screen shown in FIG. 3 is moved in the right direction. The Doppler spectrum data 202 displayed as a spectrum shown in FIG. 4 is temporally older by approximately one cardiac cycle period than that shown in FIG. 3. This is the difference therebetween.

Specifically, the D-mode image 201 shown in FIG. 4 includes four cardiac cycle periods newly including a cardiac cycle period 205e in addition to the cardiac cycle periods 205b, 205c, and 205d. A region on the right side of the cardiac cycle period 205b represents a time period that is shorter than one cardiac cycle, and corresponds to part of the cardiac cycle period 205a, which is shown in FIG. 3. A dashed line 204f representing an end diastole is newly shown in addition to the dashed lines 204b, 204c, 204d, and 204e each representing an end diastole. The end diastole 204a, which is shown in FIG. 3, is moved in the right direction and is not displayed on the display screen shown in FIG. 4. Also, the trace waveform 203 of the Doppler spectrum data 202 is superposed and displayed on the D-mode image 201. The trace waveform 203 is constituted from the partial trace waveforms 203b, 203c, 203d, and 203e, which respectively correspond to the cardiac cycle periods 205b, 205c, 205d, and 205e and the part 203a that is positioned on the right side of the end diastole 204b.

In the present embodiment as described above, the selection criterion is set that indicates that the temporally latest one cardiac cycle period is selected as a measurement target cardiac cycle period. In this case, the cardiac cycle period 205b, which is positioned at the rightmost position, is selected as the measurement target cardiac cycle period from among the four cardiac cycle periods 205b, 205c, 205d, and 205f shown in the D-mode image 201 displayed on the display device 102.

In this way, in the case where the cardiac cycle period selector 10 selects the temporally latest cardiac cycle period, the operator can select, as a measurement target cardiac cycle period with respect to which various diagnostic parameters are to be measured, a desired one of the cardiac cycle periods shown in the Doppler spectrum data 202 displayed as a spectrum only by performing a simple operation of moving the desired cardiac cycle period displayed as a spectrum so as to be positioned largely on the right side on the display screen.

As is the case in FIG. 3, it is often the case that the rightmost region which is the temporally latest in the D-mode image 201 of the Doppler spectrum data 202 displayed as a spectrum shown in FIG. 4 represents only a time period corresponding to part of one cardiac cycle period. The temporally latest cardiac cycle period in this case is a time period between the end diastole 204b, which is positioned on the left side in the rightmost region displayed as a spectrum in the Doppler spectrum data 202, and the end diastole 204c, which is positioned on the left side of the end diastole 204b.

The operator can select, as a measurement target cardiac cycle period with respect to which the various diagnostic parameters are to be measured, a desired cardiac cycle period with respect to which the operator hopes to measure the various diagnostic parameters from among the cardiac cycle periods displayed as a spectrum which is shown in the D-mode image 201, only by moving the Doppler spectrum data 202 displayed as a spectrum including the desired cardiac cycle period displayed as a spectrum such that the desired cardiac cycle period is positioned at the rightmost position on the display screen. Specifically, when the operator moves the Doppler spectrum data 202 displayed as a spectrum in the right direction, and as a result only a time period corresponding to only part of one cardiac cycle period displayed as a spectrum exists on the right side of the desired cardiac cycle period displayed as a spectrum, the desired cardiac cycle period is selected as the measurement target cardiac cycle period with respect to which the various diagnostic parameters are to be measured.

The cardiac cycle period selector 10 outputs the partial trace waveform 203b, which corresponds to the cardiac cycle period 205b selected as the measurement target cardiac cycle period, to the measure 11. Alternatively, the cardiac cycle period selector 10 may output the whole trace waveform 203 to the measure 11.

Also, as is the case in FIG. 3, as shown in FIG. 4 for example, the partial trace waveform 203b, which corresponds to the cardiac cycle period 205b selected as the measurement target cardiac cycle period, may be highlighted compared with the partial trace waveforms 203c, 203d, and 203e, which respectively correspond to the other cardiac cycle periods 205c, 205d, and 205e. Alternatively, only the partial trace waveform 203b, which corresponds to the cardiac cycle period 205b selected as the measurement target cardiac cycle period, may be displayed while the other partial trace waveforms 203c, 203d, and 203e, which respectively correspond to the other cardiac cycle periods 205c, 205d, and 205e, are not displayed.

### Step 12 (S012)

Step 12 (S012) is a step in which the measure 11 measures various diagnostic parameters with use of a partial trace waveform corresponding to the measurement target cardiac cycle period which is set in Step 11 (S011). The measure 11 measures the various diagnostic parameters with use of the partial trace waveform 203d corresponding to the cardiac cycle period 205d, which is selected as the measurement target cardiac cycle period. The various diagnostic parameters for example include PS, EDV, TAMV, RI, PI, and the like, as described above. However, a diagnostic parameter to be measured by the measure 11 does not necessarily need to be the above various diagnostic parameters. Alternatively, the measure 11 may measure other diagnostic parameters.

The measure 11 outputs measurement results of the various diagnose parameters, which are measured with use of the trace waveform part 203d, to the display processor 8.

### Step 13 (S013)

Step 13 (S013) is a step in which the display processor 8 controls the display device 102 to display the measurement results of the various diagnostic parameters. For example as shown in FIG. 3 and FIG. 4, the display processor 8 superposes and displays measurement results 206 of PSV, EDV, TAMV, RI, and PI on the D-mode image 201.

### Step 14 (S014)

Step 14 (S014) is a step in which the controller 12 judges whether an operation input instructing to change a D-mode image to be displayed has been made by the operator on the operation inputter 2. Change of a D-mode image to be displayed indicates to move the Doppler spectrum data 202 displayed as a spectrum along the time (t) on the horizontal axis, in the same manner as in Step 8 (S008).

The controller 12 judges whether an operation input instructing to change a D-mode image to be displayed has been made by the operator on the operation inputter 2 within for example a predetermined period such as several tens of seconds.

(A-1) Case Where Operation Input Instructing to Change D-Mode Image to be Displayed Has Been Made Within Predetermined Period

The operator can scroll the Doppler spectrum data displayed as a spectrum, which is to be displayed within the predetermined period, in the forward and backward directions along the time (t) on the horizontal axis. In the case where an operation input instructing to change a D-mode image to be displayed has been made within the predetermined period (“Yes” in FIG. 2), the flow proceeds to Step 7 (S007).

(A-2) Step 7 (S007) Subsequent to Step 14 (S014)

Step 7 (S007) subsequent to Step 14 (S014) is a step in which, in accordance with the operation input instructing to change a D-mode image to be displayed has been made, a D-mode image is newly generated with respect to another partial range on the time axis of the Doppler spectrum data to be displayed on the display device 102, and the newly generated D-mode image is displayed on the display device 102. The same processing is performed as in the case where the flow returns to Step 7 (S007) after Step 8 (S008).

The cine player 7 outputs the newly read partial range on the time axis of the Doppler spectrum data and corresponding B-mode frame data to the display processor 8. The display processor 8 controls the display device 102 to display a B-mode image and a D-mode image. After that, the flow proceeds to Step 8 (S008).

(B) Case Where no Operation Input Has Been Made Within Predetermined Period

In the case where no operation input has been made within the predetermined period (“No” in FIG. 2), the flow ends.

### Summary

According to the ultrasound diagnostic device 100 relating to the present embodiment with the above configuration, in the case where the D-mode image 201 that is displayed in real time is frozen, it is possible to, only with a simple operation, select the cardiac cycle period 205a as a measurement target cardiac cycle period from the trace waveform 203 of the frozen D-mode image 201, and thereby to measure the various diagnostic parameters with use of the partial trace waveform 203a corresponding to the selected cardiac cycle period 205a.

Also, the same applies to the case where the cine player 7 newly generates a D-mode image 201 and a trace waveform 203 with respect to another partial range on the time axis of the Doppler spectrum data 202 in accordance with the operation input, and as a result a plurality of cardiac cycle periods shown in the D-mode image 201 are changed. Even in this case, it is possible to, only with a simple operation, select the cardiac cycle period 205a as a measurement target cardiac cycle period from the trace waveform 203 of the D-mode image 201, and thereby to measure the various diagnostic parameters with use of the partial trace waveform 203a corresponding to the selected cardiac cycle period 205a.

As described above, the operator can measure various diagnostic parameters only with a simple operation with respect to a desired cardiac cycle period the operator hopes to measure the various diagnostic parameters from among a plurality of cardiac cycle periods that are displayed as a spectrum.

(Measurement Operations of Various Diagnostic Parameters Performed in the Case Where D-Mode Image is Cine-Played Back)

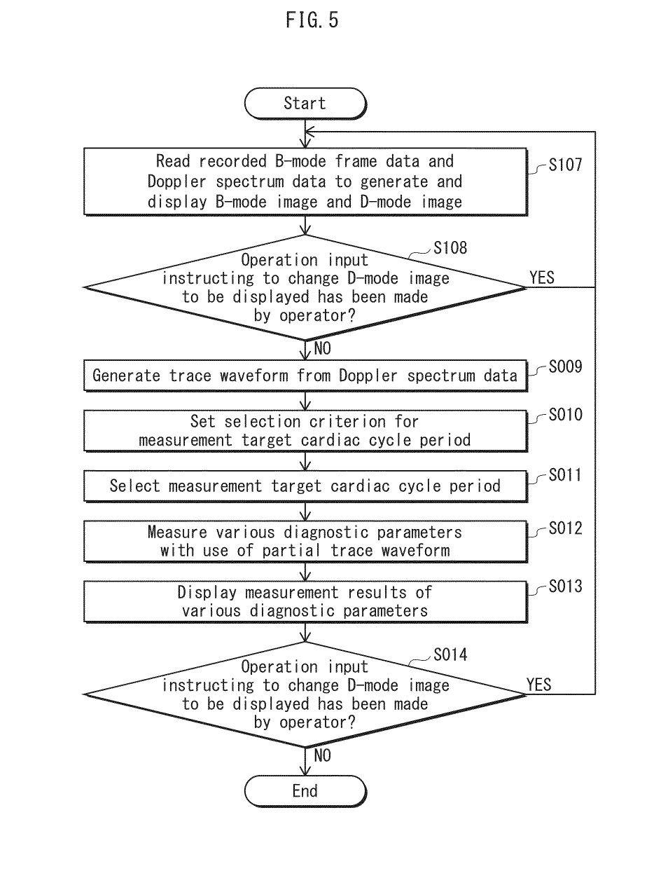

Description is given on measurement operations of various diagnostic parameters performed in the case where a D-mode image is cine-played back. FIG. 5 is a flow chart showing measurement operations of the various diagnose parameters performed in the case where a D-mode image is cine-played back in the ultrasound diagnostic device 100 relating to the present embodiment. This flow chart shows a control method of the ultrasound diagnostic device 100, including an operation input from the operator. Operations performed on a D-mode image which is cine-played back are similar to operations of Step 7 (S007) to Step 14 (S014) in the measurement operations shown in FIG. 2, which is performed in the case where a D-mode image which is displayed in real time is frozen. In the following, steps that are different from those in FIG. 2 are described using different step numbers.

### Step 107 (S107)

Step 107 (S007) is a step in which the cine player 7 reads B-mode frame data and corresponding Doppler spectrum data, which have been obtained in the past and recorded in the cine recorder 6, outputs the B-mode frame data and Doppler spectrum data to the display processor 8, and the display processor 8 controls the display device 102 to display a B-mode image and a D-mode image.

First, the operator performs an operation for cine-playing back the data recorded in the cine recorder 6, via the operation inputter 2. The display processor 8 acquires B-mode frame data that have been obtained in the past and recorded in the cine player 7, generates a B-mode image from the B-mode frame data, and controls the display device 102 to display the B-mode image. Similarly, the display processor 8 acquires Doppler spectrum data that corresponds to the B-mode frame data and has been obtained in the past and recorded in the cine player 7, generates a D-mode image from the Doppler spectrum data, and controls the display device 102 to display the D-mode image. A D-mode image 201 that is displayed here is the same as that shown in FIG. 4.

Here, in the case where a plurality of pairs of B-mode frame data and corresponding Doppler spectrum data have been obtained in the past and recorded in the cine recorder 6, the operator can select one of the pairs of data that is to be played back by performing an operation on the operation inputter 2.

### Step 108 (S108)

Step 8 (S108) is a step in which the controller 12 judges whether an operation input instructing to change a D-mode image to be displayed has been made by the operator on the operation inputter 2. Change of a D-mode image to be displayed is the same as that shown in FIG. 2.

The operator can move the Doppler spectrum data displayed as a spectrum in both the forward and backward directions along the time (t) on the horizontal axis shown in FIG. 4 by performing a predetermined operation on the operation inputter 2, as described above.

The controller 12 judges whether an operation input instructing to change a D-mode image to be displayed such as described above has been made by the operator on the operation inputter 2 within a predetermined period such as two to three seconds.

(A-1) Case Where Operation Input Instructing to Change D-Mode Image to be Displayed Has Been Made Within Predetermined Period

In the case where an operation input instructing to change a D-mode image to be displayed has been made within the predetermined period (“Yes” in FIG. 5), the flow proceeds to Step 107.

As described above, the B-mode image and the D-mode image, which are respectively generated from the B-mode frame data as of the time when the cine playback has been started and the corresponding Doppler spectrum data, are displayed on the display device 102. Here, the time when the cine playback has been started, for example, often coincides with the latest time on time axis of a pair of B-mode frame data that is a target and corresponding Doppler spectrum data which are read by the cine player 7 (hereinafter, referred to as target data set). Alternatively, in the case where a target set has been cine-played back in the past one or more number of times, a time when the cine playback of the target set has been started may coincide with a time when an immediate previous playback operation of the target set has been completed.

Accordingly, in the former case, the operator can move the Doppler spectrum data displayed as a spectrum in the backward direction along the time (t) on the horizontal axis, and after that, the Doppler spectrum data displayed as a spectrum in the forward direction along the time (t) on the horizontal axis. Also, in the latter case, the operator can move the Doppler spectrum data displayed as a spectrum in both the forward and backward directions along the time (t) on the horizontal axis.

In this way, the operator can scroll the Doppler spectrum data displayed as a spectrum, which is to be displayed within the predetermined period, in the forward and backward directions along the time (t) on the horizontal axis. After that, in the case where no new operation input has been made within the predetermined period, the flow proceeds to Step 7 (S107).

(A-2) Step 107 (S107) Subsequent to Step 108 (S108)

Step 107 (S107) subsequent to Step 108 (S108) is the same as Step 7 (S007) subsequent to Step 8 (S008), and accordingly the detailed description thereof is omitted. In accordance with the operation input, the cine player 7 shifts the partial range on the time axis of the Doppler spectrum data, and reads the shifted partial range on the time axis of the Doppler spectrum data. The cine player 7 also reads B-mode frame data corresponding to the shifted partial range. After that, the cine player 7 outputs the newly read partial range on the time axis of the Doppler spectrum data and corresponding B-mode frame data to the display processor 8. The display processor 8 controls the display device 102 to display a B-mode image and a D-mode image. After that, the flow proceeds to Step 8 (S008).

(B) Case Where no Operation Input Has Been Made Within Predetermined Period

In the case where no operation input instructing to change a D-mode image to be displayed has been made within the predetermined period (“No” in FIG. 5), the flow proceeds to Step 9 (S009). Note that Step 9 (S009) to Step 14 (S014) in FIG. 5 are the same as those in FIG. 2, and accordingly description thereof is omitted.

### Summary

According to the ultrasound diagnostic device 100 relating to the present embodiment with the above configuration, even in the case where B-mode frame data and corresponding Doppler spectrum data, which have been obtained in the past and recorded in the cine recorder 6, are read and cine-played back, it is possible to, only with a simple operation, select the cardiac cycle period 205a as a measurement target cardiac cycle period from the trace waveform 203 of the D-mode image 201 which is cine-played back to measure the various diagnostic parameters with use of the partial trace waveform 203a corresponding to the selected cardiac cycle period 205a.

Also, the same applies to the case where while the D-mode image 201 is cine-played back, the cine player 7 newly generates a D-mode image 201 and a trace waveform 203 by shifting the partial range on the time axis of the Doppler spectrum data 202 in accordance with the operation input, and as a result a plurality of cardiac cycle periods shown in the D-mode image 201 are changed. Even in this case, it is possible to, only with a simple operation, select the cardiac cycle period 205a as a measurement target cardiac cycle period from the trace waveform 203 of the D-mode image 201, and thereby to measure the various diagnostic parameters with use of the partial trace waveform 203a corresponding to the selected cardiac cycle period 205a.

In the case where the cardiac cycle period selector 10 selects the temporally latest cardiac cycle period for example, the operator can measure various diagnostic parameters with respect to a desired one of the cardiac cycle periods shown in the Doppler spectrum data 202 displayed as a spectrum only by performing a simple operation of moving the desired cardiac cycle period displayed as a spectrum so as to be positioned largely on the right side on the display screen.

In this way, the operator can measure the various diagnostic parameters with respect to a desired cardiac cycle period the operator hopes to measure the various diagnostic parameters only with a simple operation by selecting, from among a plurality of cardiac cycle waveforms of a subject, a characteristic cardiac cycle waveform, a typical cardiac cycle waveform, or a cardiac cycle waveform that is regarded as in a mean state in consideration of measurement results, cardiac cycle variation, and so on.

### Modification 1

In the embodiment, the selection criterion for a measurement target cardiac cycle period is set that indicates that the temporally latest cardiac cycle period is selected from among cardiac cycle periods corresponding to a trace waveform corresponding to a D-mode image which are simultaneously displayed on the display device 102. Alternatively, the selection criterion for a measurement target cardiac cycle period may be appropriately changed. For example, a selection criterion may be set that indicates that a cardiac cycle period that is designated by the operator from among the cardiac cycle periods corresponding to the trace waveform corresponding to the D-mode image which are displayed on the display device 102, for example via an operation input made by on the operation inputter 2.

An ultrasound diagnostic device relating to the present modification is characterized in that the selection criterion for a measurement target cardiac cycle period is configured as follows. According to this selection criterion, specifically, the operation inputter 2 receives an operation input instructing to designate a measurement target range on a D-mode image displayed on the display device 102, the image controller 13 controls the display device 102 to display the measurement target range, and the cardiac cycle period selector 10 selects, as a measurement target cardiac cycle period, a cardiac cycle period that is included in the measurement target range from among a plurality of cardiac cycle periods shown in the D-mode image displayed on the display device 102.

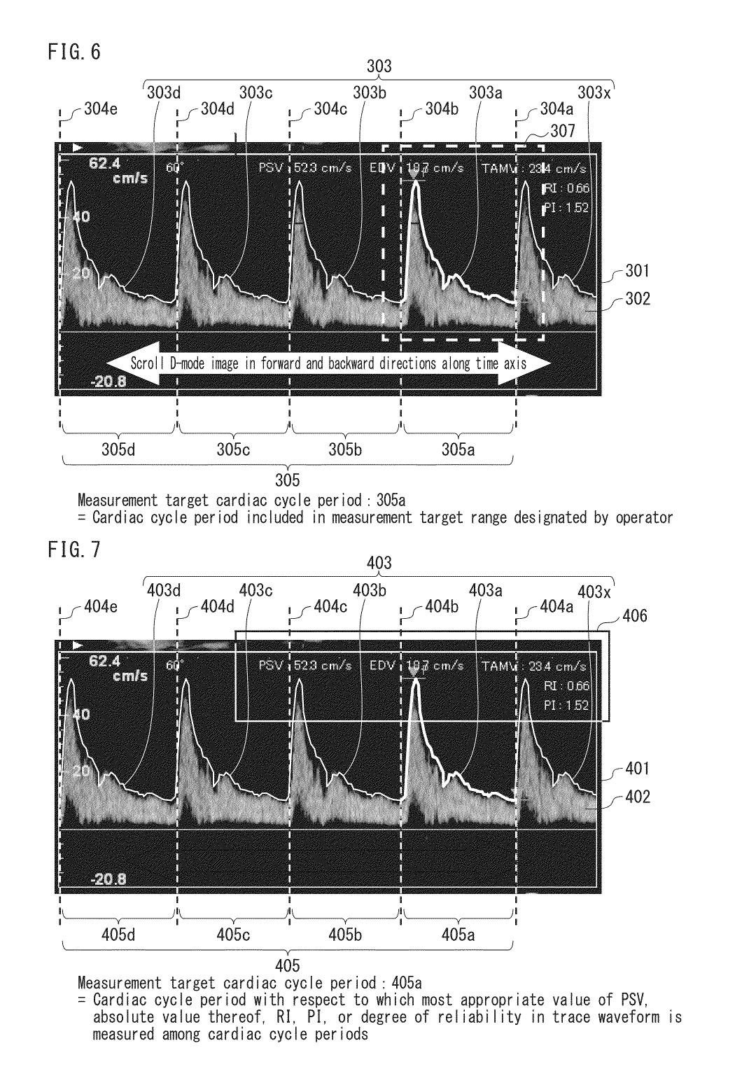

FIG. 6 is a schematic view showing an example of a D-mode image in Modification 1 of the ultrasound diagnostic device 100 relating to the embodiment. A D-mode image 301 shows Doppler spectrum data 302 that is displayed as a spectrum. A trace waveform 303 of the Doppler spectrum data 302 is superposed and displayed on the D-mode image 301. The D-mode image 301 shows end diastoles 304a, 304b, 304c, 304d, and 304e that are detected from the trace waveform 203 and cardiac cycle periods 305a, 305b, 305c, and 305d that are each a time period between each two adjacent end diastoles. The trace waveform 303 is constituted from partial trace waveforms 303a, 303b, 303c, and 303d that respectively correspond to the cardiac cycle periods 305a, 305b, 305c, and 305d and a part 303x that is positioned on the right side of the end diastole 304a. The D-mode image 301 and the trace waveform 303 as described above have the same configuration as those shown in FIG. 3.

In the present modification, the D-mode image 301 shows a measurement target range 307 that is input from the operator via an operation input made on the operation inputter 2. Specifically, the operator makes an operation input instructing to designate a position on the measurement target range on the D-mode image 301 displayed on the display device 102, and the display processor 8 displays the measurement target range 307 on the designated position on the D-mode image 301.

The position of the measurement target range 307 on the D-mode image 301 is not particularly limited. However, the measurement target range 307 needs to have at least a sufficient length for including the number of cardiac cycles of the Doppler spectrum data 302 with respect to which various diagnostic parameters are to be measured. In the case where the various diagnostic parameters are measured with respect to one cardiac cycle period for example, the measurement target range 307 needs to be set to have a length that is longer than one cardiac cycle period and shorter than two cardiac cycle periods.

The cardiac cycle period selector 10 selects, as a measurement target cardiac cycle period, the cardiac cycle period 305a which is included in the measurement target range 307 from among the cardiac cycle periods 305a, 305b, 305c, and 305d shown in the D-mode image displayed on the display device 102. After that, the measure 11 measures various diagnostic parameters such as PSV and EDV with use of the partial trace waveform 303a, which corresponds to the cardiac cycle period 305a selected as the measurement target cardiac cycle period.

At this time, the operator can measure the various diagnostic parameters with respect to a desired cardiac cycle period among the cardiac cycle periods shown in the Doppler spectrum data 302 displayed as a spectrum only by performing a simple operation of moving the Doppler spectrum data 302 displayed as a spectrum such that the desired cardiac cycle period displayed as a spectrum is positioned largely within measurement target range 307. The operator moves the Doppler spectrum data 302 displayed as a spectrum including the desired cardiac cycle period toward the measurement target range 307. When the desired cardiac cycle period displayed as a spectrum falls within the measurement target range 307, the various diagnostic parameters are measured with respect to the desired cardiac cycle period.

Also, as is the case in FIG. 3, as shown in FIG. 6 for example, the partial trace waveform 303a, which corresponds to the cardiac cycle period 305a selected as the measurement target cardiac cycle period, may be highlighted compared with the partial trace waveforms 303c, 303d, and 303e, which respectively correspond to the other cardiac cycle periods 305c, 305d, and 305e.

### Modification 2

An ultrasound diagnostic device relating to the present modification is characterized in that the selection criterion for a measurement target cardiac cycle period is configured as follows. According to this selection criterion, specifically, the measure 11 measures a parameter selected from among PSV, an absolute value thereof, RI, PI, and a reliability degree of the trace waveform from the whole trace waveform corresponding to all cardiac cycle periods shown in a D-mode image displayed on the display device 102. After that, the cardiac cycle period selector 10 selects, as a measurement target cardiac cycle period, a cardiac cycle period with respect to which a measured value of the parameter is the most appropriate from among the cardiac cycle periods shown in the D-mode image displayed on the display device 102.

FIG. 7 is a schematic view showing an example of a D-mode image in Modification 2 of the ultrasound diagnostic device 100 relating to the embodiment. A D-mode image 401 shows Doppler spectrum data 402 that is displayed as a spectrum. A trace waveform 403 of the Doppler spectrum data 402 is superposed and displayed on the D-mode image 401. The D-mode image 401 shows end diastoles 404a, 404b, 404c, 404d, and 404e that are detected from the trace waveform 403 and cardiac cycle periods 405a, 405b, 405c, and 405d that are each a time period between each two adjacent end diastoles. The trace waveform 403 is constituted from partial trace waveforms 403a, 403b, 403c, and 403d that respectively correspond to the cardiac cycle periods 405a, 405b, 405c, and 405d and a part 403x that is positioned on the right side of the end diastole 404a. The D-mode image 401 and the trace waveform 403 as described above have the same configuration as those shown in FIG. 3.

In the present modification, the cardiac cycle period selector 10 measures a parameter selected from among PSV, an absolute value thereof, RI, PI, and a degree of reliability in trace waveform, with use of the partial trace waveforms 403a, 403b, 403c, and 403d, which respectively correspond to the cardiac cycle periods 405a, 405b, 405c, and 405d shown in the D-mode image displayed on the display device 102. After that, the cardiac cycle period selector 10 selects, as a measurement target cardiac cycle period, a cardiac cycle period with respect to which a measured value of the parameter is the most appropriate. The cardiac cycle period with respect to which the measured value of the parameter is the most appropriate, which is selected as the measurement target cardiac cycle period, may be for example one cardiac cycle period with respect to which the highest value of PSV, the absolute value thereof, PSV, the absolute value thereof, RI, PI, or the degree of reliability in trace waveform is measured. These parameters are used as a reference for judging a preferable part of a trace waveform for the operator to measure the various diagnostic parameters. In the example in FIG. 7, the cardiac cycle period 405a is selected as the measurement target cardiac cycle period. The measure 11 measures all of the various diagnostic parameters with use of the partial trace waveform 403a corresponding to the cardiac cycle period 405a.

Also, as is the case in FIG. 3, as shown in FIG. 7 for example, the partial trace waveform 403a, which corresponds to the cardiac cycle period 405a selected as the measurement target cardiac cycle period, may be highlighted compared with the partial trace waveforms 403c, 403d, and 403e, which respectively correspond to the other cardiac cycle periods 405c, 405d, and 405e.

Note that the degree of reliability in trace waveform indicates the degree of smooth in trace waveform. A trace waveform having a higher degree of smooth may be judged to have a higher degree of reliability. Alternatively, a trace waveform having a higher correlation with a trace waveform that is prepared as a model beforehand may be judged to have a higher degree of reliability as a result of comparison with the model.

Also in the present modification, the operator can successively select an optimal cardiac cycle period for measurement, and measure various diagnostic parameters with respect to the selected cardiac cycle period only by performing a simple operation with the operation inputter 2 of selecting the partial range of the Doppler spectrum data 302 on the time axis to be displayed on the display screen of the display device 102 from among the Doppler spectrum data 302 showing a plurality of cardiac cycle periods which is recorded in the cine recorder 6.

Note that the measure 11 may measure a plurality of parameters selected from among PSV, the absolute value thereof, RI, PI, and the degree of reliability in trace waveform, and the cardiac cycle period selector 10 may select, as a measurement target cardiac cycle period, a cardiac cycle period with respect to which respective measured values of the selected parameters are each the most appropriate.

### Other Modifications

(1) In the embodiment, the ultrasound probe 101 includes the plurality of piezoelectric elements that are arranged in a one-dimensional array. However, the ultrasound probe 101 is not limited to have such a configuration. Alternatively, an ultrasound probe may be used which for example include a plurality of piezoelectric elements that are arranged in a two-dimensional array. In a configuration in which the ultrasound probe includes piezoelectric elements which are arranged in a two-dimensional array, transmission position and direction of ultrasound beams can be controlled by the controller 12 adjusting timing and magnitude of voltage application to each of the piezoelectric elements.

(2) The ultrasound probe 101 may have part of the functions of the transmission and reception processor 3. For example, the ultrasound probe may generate a transmission electrical signal in the ultrasound probe based on a control signal for generating a transmission electrical signal that is output from the transmission and reception processor 3, and convert the transmission electrical signal to an ultrasound wave. The ultrasound probe 101 may also convert a reflected ultrasound wave received thereby to a reception electrical signal, and generate a reception signal in the ultrasound probe based on the reception electrical signal.

(3) In the embodiment, in order to measure various diagnostic parameters, the trace waveform generator 9 generates a trace waveform from Doppler spectrum data. Alternatively, the D-mode data generator 5 may generate a trace waveform at the same time when generating Doppler spectrum data. In this case, the generated trace waveform and Doppler spectrum data are recorded together in the cine recorder 6, and are played back by the cine player 7.

(4) In the embodiment, Doppler spectrum data is generated from reception signals corresponding to a range indicated by a sample gate set for obtaining a B-mode image in real time, and the generated Doppler spectrum data is recorded in the cine recorder 6. Alternatively, Doppler spectrum data may be generated as follows. Specifically, all reception signals are recorded in the cine recorder 6, and when a B-mode image is cine-played back, a sample gate is set at a desired position on the B-mode image, and Doppler spectrum data is generated from reception signals corresponding to a range indicated by the set sample gate. It is possible to play back a D-mode image by setting the sample gate at an arbitrary position.

(5) In the embodiment, the cine recorder 6, which is a recording medium for recording B-mode frame data and corresponding Doppler spectrum data, is included in the ultrasound diagnostic device 100. Alternatively, since the cine recorder 6, which is a recording medium, only needs to record B-mode frame data and corresponding Doppler spectrum data, the cine recorder 6 may be provided separately outside the ultrasound diagnostic device 100. For example, the cine recorder 6, which is a recording medium, may be provided in an external storage device other than the ultrasound diagnostic device 100 or may be connected with a server via a network.

(6) In the embodiment, the blocks constituting the control circuit 1 are each an independent piece of hardware. However, the blocks constituting the control circuit 1 are not limited to being independent pieces of hardware, and alternatively, functions of each of the blocks may be for example implemented as necessary through a CPU and software that are integrated together.

Also, the blocks constituting the control circuit 1 may be typically implemented as an LSI that is an integrated circuit. The blocks may be integrated individually into a single chip. Alternatively, some or all of the blocks may be collectively integrated into a single chip. Note that depending on the degree of integration, an LSI may be referred to as an IC, a system LSI, a super LSI, or an ultra LSI.

Also, circuit integration is not limited to LSI, and may be alternatively realized through a dedicated circuit or a general processor. A field programmable gate array (FPGA), which is programmable after the LSI is manufactured, or a reconfigurable processor, which allows for reconfiguration of the connection and setting of circuit cells inside the LSI, may be alternatively used.

Furthermore, if technology for forming integrated circuits that replaces LSI were to emerge, owing to advances in semiconductor technology or to another derivative technology, the integration of the blocks may be naturally accomplished using such technology.

### Conclusion

The ultrasound diagnostic device 100 relating to the present embodiment is the ultrasound diagnostic device that is connectable with the recording medium 6 and the display device 102, the ultrasound diagnostic device 100 comprising: the operation inputter 2 that receives an operation input from a user; the image controller 13 that reads Doppler spectrum data corresponding to a plurality of cardiac cycles that is recorded in the recording medium 6, generates a D-mode image and a trace waveform with respect to a partial range on a time axis of the Doppler spectrum data, and controls the display device 102 to display part or all of the D-mode image; the cardiac cycle period selector 10 that detects a plurality of cardiac cycle periods shown in the D-mode image from the trace waveform, and selects at least one cardiac cycle period from among the detected cardiac cycle periods as a measurement target cardiac cycle period according to a predetermined selection criterion; and the measure 11 that measures a predetermined diagnostic parameter with use of part of the trace waveform corresponding to the measurement target cardiac cycle period, wherein when the operation inputter 2 receives an operation input instructing to change a D-mode image to be displayed from the D-mode image that is displayed to another D-mode image, the image controller 13 newly generates the other D-mode image and a trace waveform with respect to another partial range on the time axis of the Doppler spectrum data in accordance with the operation input, and controls the display device to display the newly generated D-mode image, the cardiac cycle period selector 10 newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and the measure 11 measures the diagnostic parameter with use of part of the newly generated trace waveform corresponding to the newly selected measurement target cardiac cycle period.

With the above configuration, even in the case where a D-mode image is frozen or even in the case where a D-mode image showing past cardiac cycles is cine-played back, the present invention allows measurement of various diagnostic parameters only with a simple operation.

Accordingly, an operator can measure various diagnostic parameters only with a simple operation with respect to a desired cardiac cycle period the operator hopes to measure the various diagnostic parameters among a plurality of cardiac cycle periods that are displayed as a spectrum. As a result, the operator can measure the various diagnostic parameter by selecting, from among a plurality of cardiac cycle waveforms of a subject, a characteristic cardiac cycle waveform, a typical cardiac cycle waveform, or a cardiac cycle waveform that is regarded as in a mean state in consideration of measurement results, cardiac cycle variation, and so on.

Therefore, even if an operator does not have a skill, the operator can measure the various diagnostic parameters only with a simple operation. As a result, it is possible for even an unskilled operator to accurately measure the various diagnostic parameters in a short time period, thereby increasing efficiency in diagnose.

### Supplement

The embodiment described above is a mere preferable example of the present invention. The numerical values, shapes, materials, constitutional elements, the arrangement and connection of the constitutional elements, steps, the processing order of the steps, etc., shown in the embodiment are mere examples, and therefore do not limit the spirit and scope of the present invention. Also, among the constitutional elements described in the embodiment, constitutional elements that are not described in the independent claims and indicate a general concept of the present invention are optional constitutional elements that are included in order to explain preferred embodiments of the present invention.

Also, in order to facilitate understanding the invention, the constitutional elements are not necessarily illustrated to scale in the drawings referred to in the embodiment. Moreover, the present invention is not limited by the embodiment, and appropriate modifications may be made so long as such modifications do not cause deviation from the general concept of the present invention.

Furthermore, although materials such as circuit parts, lead wires, etc., on a substrate are included in the ultrasound diagnostic device, electrical wiring and electric circuits may have a wide variety of implementations based on common knowledge in the technical field of ultrasound diagnostic devices and so on, and are therefore omitted from the description as they have no direct relevance to the description of the present invention. Note that each drawing described above is schematic, and is not an exact representation.

### INDUSTRIAL APPLICABILITY

The present invention allows measurement of various diagnostic parameters only with a simple operation in the case where a D-mode image that is generated and displayed in real time is frozen or in the case where a D-mode image that has been obtained in the past is cine-played back. Therefore, the present invention is widely utilizable for a simply-operable ultrasound diagnostic device, a control method of the ultrasound diagnostic device, a control circuit of the ultrasound diagnostic device.

### REFERENCE SIGNS LIST

1 control circuit
2 operation inputter
3 transmission and reception processor
4 B-mode data generator
5 D-mode data generator
6 cine recorder
7 cine player
8 display processor
9 trace waveform generator
10 cardiac cycle period selector
11 measure
12 controller
13 image controller
100 ultrasound diagnostic device
101 ultrasound probe
102 display device
201, 301, and 401 D-mode image
202, 302, and 402 Doppler spectrum data
203, 303, and 403 trace waveform
204, 304, and 404 end diastole
205, 305, and 405 cardiac cycle period
206 measurement results
307 measurement target range

1-16. (canceled)

17. An ultrasound diagnostic device that is connectable with a recording medium and a display device, the ultrasound diagnostic device comprising:
an operation inputter that receives an operation input from a user;
an image controller that reads Doppler spectrum data corresponding to a plurality of cardiac cycles that is recorded in the recording medium, generates a D-mode image and a trace waveform with respect to a partial range on a time axis of the Doppler spectrum data, and controls the display device to display part or all of the D-mode image;
a cardiac cycle period selector that detects a plurality of cardiac cycle periods shown in the D-mode image from the trace waveform, and selects at least one cardiac cycle period from among the detected cardiac cycle periods as a measurement target cardiac cycle period according to a predetermined selection criterion; and
a measure that measures a predetermined diagnostic parameter with use of part of the trace waveform corresponding to the measurement target cardiac cycle period, wherein:
when the operation inputter receives an operation input instructing to change a D-mode image to be displayed from the D-mode image that is displayed to another D-mode image,
the image controller newly generates the other D-mode image and a trace waveform with respect to another partial range on the time axis of the Doppler spectrum data in accordance with the operation input, and controls the display device to display the newly generated D-mode image,
the cardiac cycle period selector newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and
the measure measures the diagnostic parameter with use of part of the newly generated trace waveform corresponding to the newly selected measurement target cardiac cycle period.

18. The ultrasound diagnostic device of claim 17, wherein:
the selection criterion indicates that a temporally latest cardiac cycle period is selected as a measurement target cardiac cycle period from among a plurality of cardiac cycle periods shown in a D-mode image displayed on the display device.

19. The ultrasound diagnostic device of claim 18, wherein:
the temporally latest cardiac cycle period is a temporally latest time period among a plurality of time periods that are each a time period between two adjacent ones of a plurality of end diastoles shown in the displayed D-mode image.

20. The ultrasound diagnostic device of claim 17, wherein:
the selection criterion indicates that a temporally earliest cardiac cycle period is selected as a measurement target cardiac cycle period from among a plurality of cardiac cycle periods shown in a D-mode image displayed on the display device.

21. The ultrasound diagnostic device of claim 20, wherein:
the temporally latest cardiac cycle period is a temporally earliest one of a plurality of time periods that are each a time period between two adjacent ones of a plurality of end diastoles shown in the displayed D-mode image.

22. The ultrasound diagnostic device of claim 17, wherein:
when the selection criterion indicates that at least one cardiac cycle period that is designated by the user from among a plurality of cardiac cycle periods shown in a D-mode image displayed on the display device is selected as a measurement target cardiac cycle period,
the operation inputter receives an operation input instructing to designate a measurement target range on the displayed D-mode image,
the image controller controls the display device to display the measurement target range, and
the cardiac cycle period selector selects at least one cardiac cycle period included in the measurement target range from among a plurality of cardiac cycle periods shown in the displayed D-mode image as a measurement target cardiac cycle period.

23. The ultrasound diagnostic device of claim 17, wherein:
when the selection criterion indicates that at least one cardiac cycle period is selected from among a plurality of cardiac cycle periods shown in the displayed D-mode image as a measurement target cardiac cycle period according to a parameter, the parameter being selected from among PSV, an absolute value thereof, RI, PI, and a degree of reliability in trace waveform that are each obtained from a trace waveform corresponding to the displayed D-mode image,
the measure further measures the parameter with respect to each of the cardiac cycle periods shown in the displayed D-mode with use of the trace waveform, and
the cardiac cycle period selector selects, as a measurement target cardiac cycle period, at least one cardiac cycle period with respect to which a measured value of the parameter is the most appropriate from among the cardiac cycle periods shown in the displayed D-mode image.

24. The ultrasound diagnostic device of claim 17, wherein:
the image controller controls the display device to display a measurement target cardiac cycle period in a different manner from a remainder of a plurality of cardiac cycle periods shown in a D-mode image displayed on the display device.

25. The ultrasound diagnostic device of claim 17, wherein:
the cardiac cycle period selector detects a plurality of cardiac cycle periods shown in a D-mode image that is displayed on the display device by detecting a plurality of end diastoles shown in the displayed D-mode image and defining a time period between each two adjacent ones of the end diastoles as one cardiac cycle period.

26. The ultrasound diagnostic device of claim 17, wherein:
the diagnostic parameter is at least one selected from among PSV, EDV, TAMV, RI, and Pl.

27. The ultrasound diagnostic device of claim 17, wherein:
when the operation inputter receives an operation input instructing to perform a freeze operation for freezing a D-mode image that is displayed on the display device,
the image controller continues to display the D-mode image as of a time when the freeze operation has been performed, and
the cardiac cycle period selector selects at least one cardiac cycle period from among a plurality of cardiac cycle periods shown in the displayed D-mode image as a measurement target cardiac cycle period according to the selection criterion.

28. The ultrasound diagnostic device of claim 17, further comprising:
a D-mode image generator that generates Doppler spectrum data corresponding to a plurality of cardiac cycles from reception signals that are obtained through transmission and reception of an ultrasound wave aimed at the inside of a subject, and outputs the Doppler spectrum data to the recording medium.

29. The ultrasound diagnostic device of claim 17, wherein:
the measure outputs measurement results of the diagnostic parameter to the image controller, and
the image controller controls the display device to display the measurement results.

30. An ultrasound diagnostic device that is connectable with a recording medium and a display device, the ultrasound diagnostic device comprising:
an operation inputter that receives an operation input from a user;
an image controller that reads reception signals corresponding to a plurality of cardiac cycles that are recorded in the recording medium, generates Doppler spectrum data with respect to a range corresponding to the reception signals, generates a D-mode image and a trace waveform with respect to a partial range on a time axis of the Doppler spectrum data, and controls the display device to display part or all of the D-mode image, the reception signals being obtained through transmission and reception of an ultrasound wave aimed at a blood vessel of a subject, the range being indicated by a sample gate that is set by the operation inputter;
a cardiac cycle period selector that detects a plurality of cardiac cycle periods shown in the D-mode image from the trace waveform, and selects at least one cardiac cycle period from among the detected cardiac cycle periods as a measurement target cardiac cycle period according to a predetermined selection criterion; and
a measure that measures a predetermined diagnostic parameter with use of part of the trace waveform corresponding to the measurement target cardiac cycle period, wherein:
when the operation inputter receives an operation input instructing to change a D-mode image to be displayed from the D-mode image that is displayed to another D-mode image,
the image controller newly generates the other D-mode image and a trace waveform with respect to another partial range on the time axis of the Doppler spectrum data in accordance with the operation input, and controls the display device to display the newly generated D-mode image,
the cardiac cycle period selector newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and
the measure measures the diagnostic parameter with use of part of the newly generated trace waveform corresponding to the newly selected measurement target cardiac cycle period.

31. A control method of an ultrasound diagnostic device that is connectable with a recording medium and a display device, the control method comprising:
generating Doppler spectrum data corresponding to a plurality of cardiac cycles from reception signals that are obtained through transmission and reception of an ultrasound wave aimed at the inside of a subject;
receiving an operation input from a user;
recording the Doppler spectrum data in the recording medium;
reading the recorded Doppler spectrum data, generating a D-mode image and a trace waveform with respect to a partial range on a time axis of the Doppler spectrum data, and controlling the display device to display part or all of the D-mode image;
detecting a plurality of cardiac cycle periods shown in the D-mode image from the trace waveform, and selecting at least one cardiac cycle period from among the detected cardiac cycle periods as a measurement target cardiac cycle period according to a predetermined selection criterion; and
measuring a predetermined diagnostic parameter with use of part of the trace waveform corresponding to the measurement target cardiac cycle period, wherein:
when an operation input instructing to change a D-mode image to be displayed from the D-mode image that is displayed to another D-mode image is received,
the other D-mode image and a trace waveform with respect to another partial range on the time axis of the Doppler spectrum data are newly generated in accordance with the operation input, and the display device is controlled to display the newly generated D-mode image,
a plurality of cardiac cycle periods shown in the newly generated D-mode image are newly detected from the newly generated trace waveform, and at least one cardiac cycle period is newly selected from among the newly detected cardiac cycle periods as a measurement target cardiac cycle period according to the selection criterion, and
the diagnostic parameter is newly measured with use of part of the newly generated trace waveform corresponding to the newly selected measurement target cardiac cycle period.

32. A control circuit that is connectable with a recording medium and a display device, and controls an ultrasound diagnostic device based on an operation input from a user received by an operation inputter included in the ultrasound diagnostic device, the control circuit comprising:
an image controller that reads Doppler spectrum data corresponding to a plurality of cardiac cycles that is recorded in the recording medium, generates a D-mode image and a trace waveform with respect to a partial range on a time axis of the Doppler spectrum data, and controls the display device to display part or all of the D-mode image;
a cardiac cycle period selector that detects a plurality of cardiac cycle periods shown in the D-mode image from the trace waveform, and selects at least one cardiac cycle period from among the detected cardiac cycle periods as a measurement target cardiac cycle period according to a predetermined selection criterion; and
a measure that measures a predetermined diagnostic parameter with use of part of the trace waveform corresponding to the measurement target cardiac cycle period, wherein:
when the operation inputter receives an operation input instructing to change a D-mode image to be displayed from the D-mode image that is displayed to another D-mode image,
the image controller newly generates the other D-mode image and a trace waveform with respect to another partial range on the time axis of the Doppler spectrum data in accordance with the operation input, and controls the display device to display the newly generated D-mode image,
the cardiac cycle period selector newly detects a plurality of cardiac cycle periods shown in the newly generated D-mode image from the newly generated trace waveform, and newly selects at least one cardiac cycle period from among the newly detected cardiac cycle periods as a measurement target cardiac cycle period according to the selection criterion, and
the measure measures the diagnostic parameter with use of part of the newly generated trace waveform corresponding to the newly selected measurement target cardiac cycle period.
